(19) United States
(12) Patent Application Publication
(10) Pub. No.: US 2025/0357960 A1
(43) Pub. Date: Nov. 20, 2025

(54) PREDICTION BASED MAXIMUM POWER EXPOSURE REPORTING

(71) Applicant: QUALCOMM Incorporated, San Diego, CA (US)

(72) Inventors: Tianyang BAI, Mountain View, CA (US); Fang YUAN, Beijing (CN); Yuwei REN, Beijing (CN); Yan ZHOU, San Diego, CA (US); Hua WANG, Basking Ridge, NJ (US); Junyi LI, Greentown, PA (US); Taesang YOO, San Diego, CA (US); Jung Ho RYU, Englewood Cliffs, NJ (US); Vasanthan RAGHAVAN, West Windsor Township, NJ (US); Qiaoyu LI, Beijing (CN); Hamed PEZESHKI, San Diego, CA (US); Mahmoud TAHERZADEH BOROUJENI, San Diego, CA (US); Tao LUO, San Diego, CA (US)

(21) Appl. No.: 18/868,603

(22) PCT Filed: Aug. 1, 2022
(86) PCT No.: PCT/CN2022/109384

§ 371 Date: Nov. 22, 2024

(51) Int. Cl. H04B 1/3827; H04W 52/22; H04W 52/36

(52) U.S. Cl. CPC H04B 1/3838; H04W 52/223; H04W 52/367

(57) ABSTRACT

A method, a computer-readable medium, and an apparatus are provided. The apparatus may be a wireless device configured to communicate with a network device. The apparatus may be configured to predict a future MPE event at the wireless device and to transmit, for the network device, an indication of the predicted future MPE event. Th apparatus may be a network node or a component of a network node configured to receive an indication of a predicted future MPE event at a UE. The network node may further be configured to adjust at least one characteristic of a communication with the UE based on the indication of the predicted future MPE event and to communicate with the UE using the at least one characteristic adjusted based on the indication of the predicted future MPE event.

### TECHNICAL FIELD

The present disclosure relates generally to communication systems, and more particularly, to predicting, and reporting, a predicted maximum power exposure (MPE) event.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device or a component of a wireless device configured to communicate with a network device. The apparatus may be configured to predict a future MPE event at the wireless device and to transmit, for the network device, an indication of the predicted future MPE event.

In an aspect of the disclosure, a method, a computer-readable medium, and an apparatus are provided. The apparatus may be a network node or a component of a network node configured to receive an indication of a predicted future MPE event at a user equipment (UE). The network node may further be configured to adjust at least one characteristic of a communication with the UE based on the indication of the predicted future MPE event and to communicate with the UE using the at least one characteristic adjusted based on the indication of the predicted future MPE event.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and UE in an access network.

FIG. 4 is a diagram illustrating a set of candidate beams for communication between a UE and a base station that may be the cause of an MPE event associated with a human hand 440.

FIG. 5 is a diagram illustrating an example of frequency modulated continuous wave (FMCW) signals generated from a radar device that may be used to measure for a beam blockage in accordance with various aspects of the present disclosure.

FIG. 6 is a call flow diagram illustrating a UE in communication with a base station in accordance with some aspects of the disclosure.

FIG. 7 is a diagram illustrating a timeline associated with a prediction of a future MPE event in accordance with some embodiments.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an apparatus.

FIG. 13 is a diagram illustrating an example of a hardware implementation for a network entity.

### DETAILED DESCRIPTION

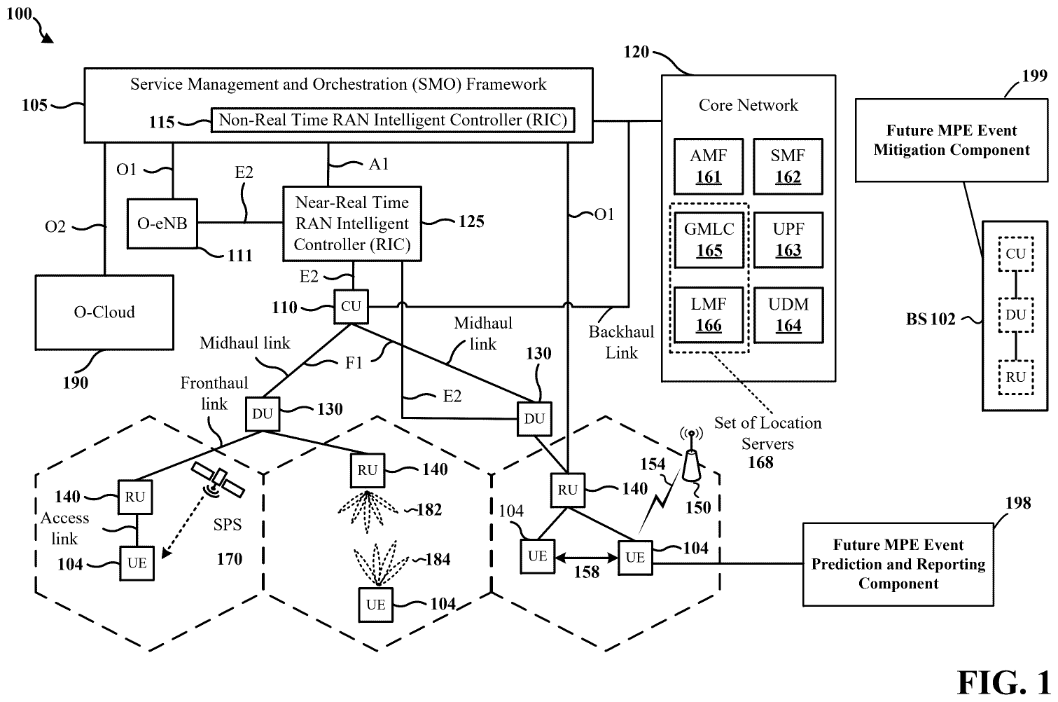

In some aspects of wireless communication, e.g., 5G NR or other radio access technologies, a maximum permissible exposure (MPE) may provide the highest energy density allowed for an exposure of a nearby (e.g., near field) human (or body part). The MPE value, in some aspects, may be defined by different standards and/or regulations for safety concerns. The MPE value, in some aspects, may be more stringent for a mmWave band (30-300 GHz), as the electromagnetic (EM) wave in the mmWave band may cause various human body resonances. Directional beamforming (BF) may be used to boost power for mmWave transmissions, such as described in connection with 182 and 184 in FIG. 1. Accordingly, the energy density for a transmission may be focused on certain BF directions, and the impact of MPE may therefore be directional.

An area around a Tx antenna, in some aspects, may be the focus of an MPE analysis and/or event related to a human user of the device associated with the Tx antenna. For example, an area within 10-100 cm may be considered to be ‘near’ the Tx antenna in some MPE test configurations, where the fingers or hands of a user of a UE (e.g., a phone, computer, or tablet) are likely to be ‘near’ the Tx antenna of the UE. In some aspects, some UEs utilizing mmWave frequencies for communication may have schemes (e.g. radar/sensor) to detect if part of a human body is within a range of the Tx antenna (e.g., exposed to the Tx power). Once detected, a UE may turn down the Tx power of the affected antenna to meet MPE regulations. In some aspects, a UL Tx beam that appears optimal before MPE detection may not be usable and/or may be less optimal than another beam after reducing the Tx power.

In some aspects of wireless communication, once a UE detects an MPE event (or issue), the maximum Tx power (e.g., a P_{CMAX,c}) associated with a serving cell, c, may be adjusted. The P_{CMAX,c}, in some aspects, may be defined as being above a lower limit (e.g., P_{CMAX L,c}) and below an upper limit (e.g., P_{CMAX H,c}). In some aspects, a calculation of the lower limit (e.g., P_{CMAX L,c}) includes a power management maximum power reduction (P-MPR) term that is related to the MPE event. In some aspects, the P-MPR may be common to all carriers and/or beams associated with a serving cell, c, or may be defined for each carrier, f, and/or beam, b, separately (e.g., a P_{CMAX, f,c} and/or a P_{CMAX, b,c}). Accordingly, a change in the P-MPR, in some aspects, may change a maximum Tx power for a UE (or a beam of the UE), and thus affect UE power headroom. Information relating to the UE power headroom, in some aspects, may be used by a network node (e.g., a base station) to make UL scheduling decision.

A UE, in some aspects, may be configured to report a change in P-MPR in a power headroom report (PHR). An event triggered report in a PHR MAC-CE may be transmitted, in some aspects, when the P-MPR is larger than a first threshold and/or the change in the P-MPR is larger than a second threshold. In some aspects, A P-MPR field, in some aspects, may be indicated in a MAC-CE, e.g., in a P-MPR field of the MAC-CE. Currently, P-MPR associated with an MPE event may be reported for detected and/or measured MPE events based on current conditions. Aspects of the present disclosure provide a method and apparatus for predicting future MPE events and reporting the predicted future MPE events to enable improved MPE event mitigation (e.g., more efficient and/or preemptive mitigation) that is less disruptive to communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface).

For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHZ-7.125 GHZ) and FR2 (24.25 GHz-52.6 GHZ). Although a portion of FR1 is greater than 6 GHZ, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a future MPE event prediction and reporting component 198 configured to communicate with a network device. The future MPE event prediction and reporting component 198 may further be configured predict a future MPE event at the wireless device and to transmit, for the network device, an indication of the predicted future MPE event. In certain aspects, the base station 102 may include a future MPE event mitigation component 199 configured to receive an indication of a predicted future MPE event at a UE. The future MPE event mitigation component 199 may further be configured to adjust at least one characteristic of a communication with the UE based on the indication of the predicted future MPE event and to communicate with the UE using the at least one characteristic adjusted based on the indication of the predicted future MPE event. Although the following description may be focused on 5G NR, the concepts described herein may be applicable to other similar areas, such as LTE, LTE-A, CDMA, GSM, and other wireless technologies.

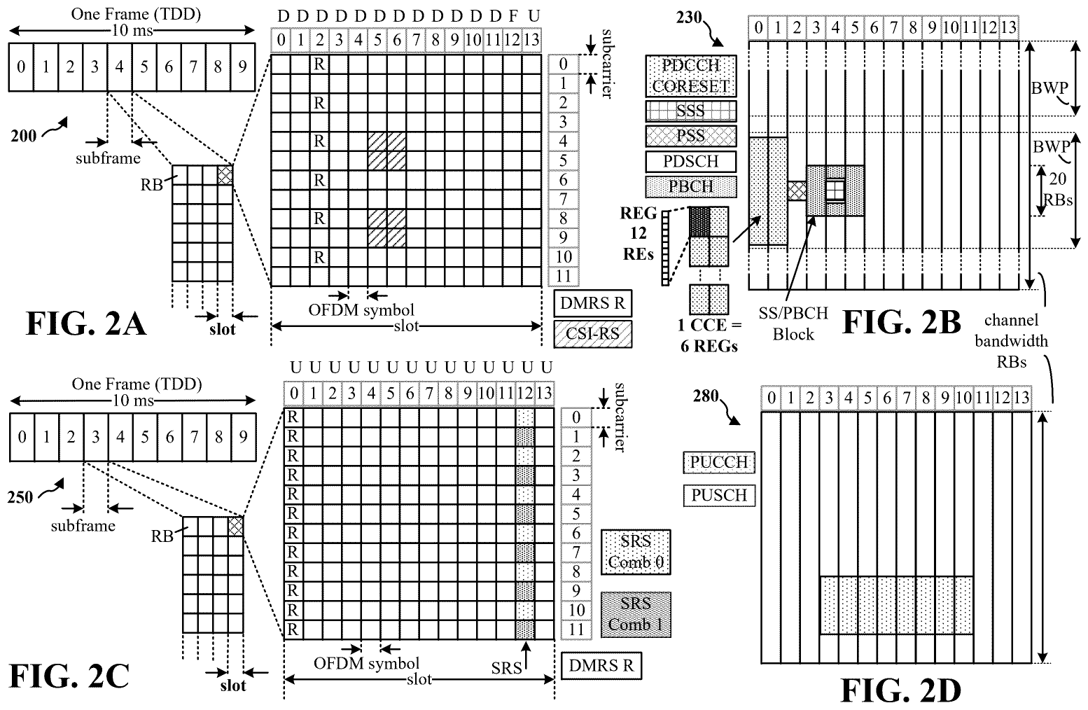

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

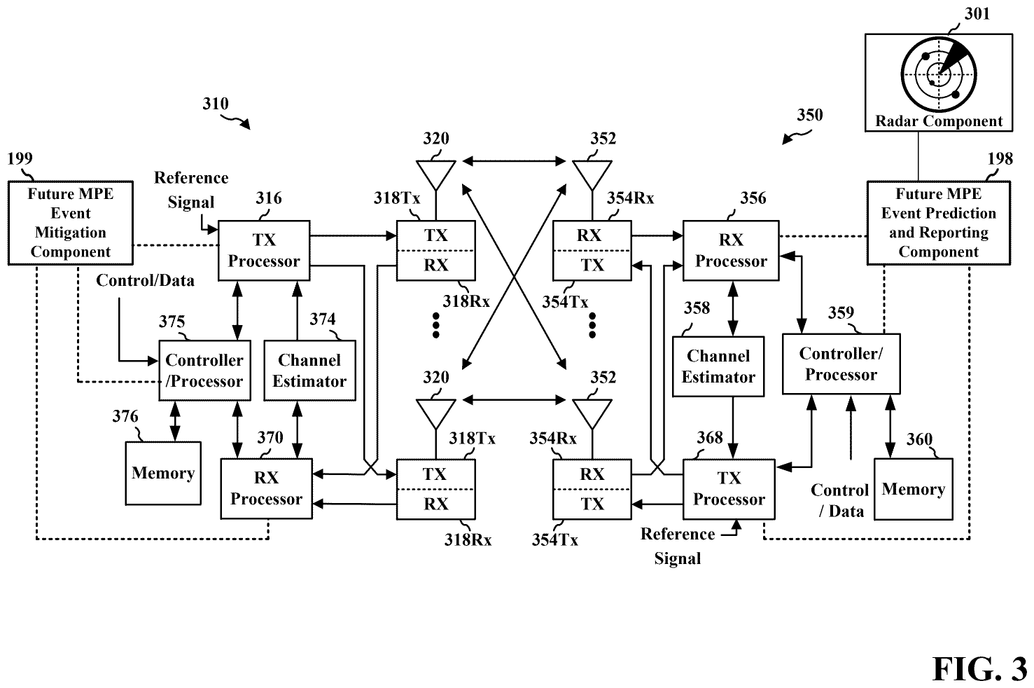

FIG. 3 is a block diagram of a base station 310 in communication with a UE 350 in an access network. As illustrated in FIG. 3, one or more of the devices may include a radar component 301. As an example, FIG. 3 illustrates the device 350 including a radar component. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the future MPE event prediction and reporting component 198 of FIG. 1.

At least one of the TX processor 316, the RX processor 370, and the controller/processor 375 may be configured to perform aspects in connection with the future MPE event mitigation component 199 of FIG. 1.

In some aspects of wireless communication, e.g., 5G NR or other radio access technologies, a maximum permissible exposure (MPE) may provide the highest energy density allowed for an exposure of a nearby (e.g., near field) human (or body part). The MPE value, in some aspects, may be defined by different standards and/or regulations for safety concerns. The MPE value, in some aspects, may be more stringent for a mmWave band (30-300 GHz), as the electromagnetic (EM) wave in the mmWave band may cause various human body resonances. Directional beamforming (BF) may be used to boost power for mmWave transmissions, such as described in connection with 182 and 184 in FIG. 1. Accordingly, the energy density for a transmission may be focused on certain BF directions, and the impact of MPE may therefore be directional.

An area around a Tx antenna, in some aspects, may be the focus of an MPE analysis and/or event related to a human user of the device associated with the Tx antenna. For example, an area within 10-100 cm may be considered to be ‘near’ the Tx antenna in some MPE test configurations, where the fingers or hands of a user of a UE (e.g., a phone, computer, or tablet) are likely to be ‘near’ the Tx antenna of the UE. In some aspects, some UEs utilizing mmWave frequencies for communication may have schemes (e.g. radar/sensor) to detect if part of a human body is within a range of the Tx antenna (e.g., exposed to the Tx power). Once detected, a UE may turn down the Tx power of the affected antenna to meet MPE regulations. In some aspects, a UL Tx beam that appears optimal before MPE detection may not be usable and/or may be less optimal than another beam after reducing the Tx power.

In some aspects of wireless communication, once a UE detects an MPE event (or issue), the maximum Tx power (e.g., a P_{CMAX,c}) associated with a serving cell, c, may be adjusted. The P_{CMAX,c}, in some aspects, may be defined as being above a lower limit (e.g., P_{CMAX L,c}) and below an upper limit (e.g., P_{CMAX H,c}). In some aspects, a calculation of the lower limit (e.g., P_{CMAX L,c}) includes a power management maximum power reduction (P-MPR) term that is related to the MPE event. In some aspects, the P-MPR may be common to all carriers and/or beams associated with a serving cell, c, or may be defined for each carrier, f, and/or beam, b, separately (e.g., a P_{CMAX, f,c} and/or a P_{CMAX, b,c}). Accordingly, a change in the P-MPR, in some aspects, may change a maximum Tx power for a UE (or a beam of the UE), and thus affect UE power headroom. Information relating to the UE power headroom, in some aspects, may be used by a network node (e.g., a base station) to make UL scheduling decision.

A UE, in some aspects, may be configured to report a change in P-MPR in a power headroom report (PHR). An event triggered report in a PHR MAC-CE may be transmitted, in some aspects, when the P-MPR is larger than a first threshold and/or the change in the P-MPR is larger than a second threshold. In some aspects, A P-MPR field, in some aspects, may be indicated in a MAC-CE, e.g., in a P-MPR field of the MAC-CE. Currently, P-MPR associated with an MPE event may be reported for detected and/or measured MPE events based on current conditions. Aspects of the present disclosure provide a method and apparatus for predicting future MPE events and reporting the predicted future MPE events to enable improved MPE event mitigation (e.g., more efficient and/or preemptive mitigation) that is less disruptive to communication.

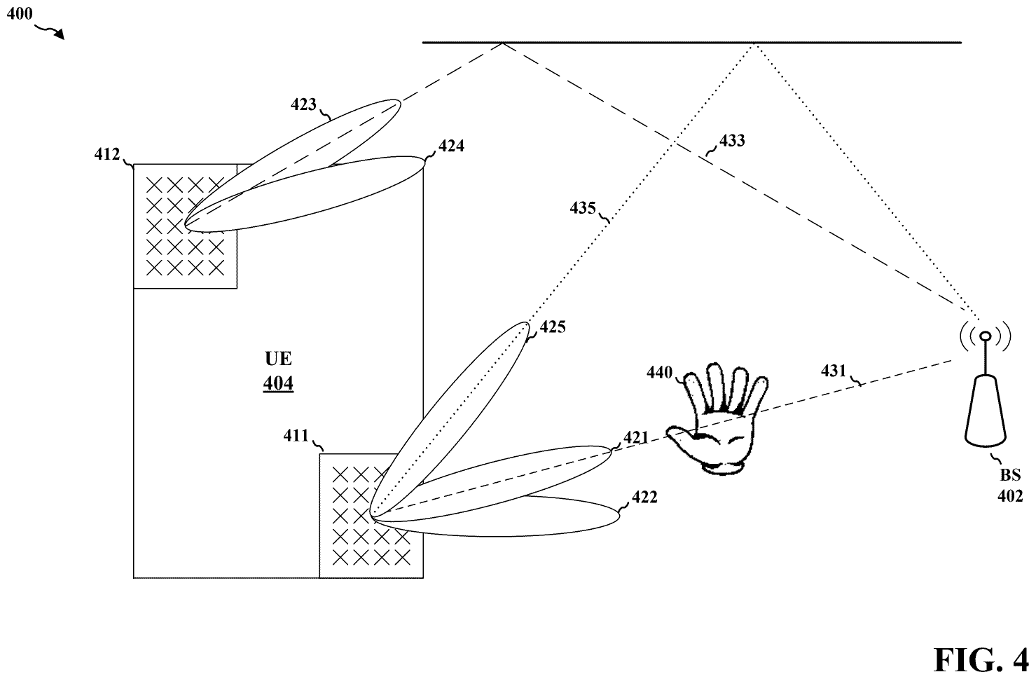

FIG. 4 is a diagram 400 illustrating a set of candidate beams for communication between a UE 404 and a base station 402 that may be the cause of an MPE event associated with a human hand 440. While FIG. 4 illustrates an MPE event in the context of communication between the UE 404 and the base station 402, the MPE event, in some aspects, may be associated with a communication between the UE 404 and a different UE or other network node. The UE 404 may include multiple antennas, e.g., antenna 411 and antenna 412. Each antenna may be associated with a set of beams that may be used to communicate with base station 402 with a threshold quality (e.g., a reference signal received power (RSRP), a reference signal received quality (RSRQ), a signal to noise ratio (SNR), signal to interference and noise ratio (SINR), or other measure of channel and/or beam quality). In some aspects, the different beams may be used and/or assessed individually or as one of a plurality of carriers when using carrier aggregation (CA).

The set of Tx beams for communication from the UE 404 to the base station 402 may include a first set of Tx beam associated with a first antenna 411 and a second set of Tx beams associated with a second antenna 412. The first set of Tx beams as illustrated in diagram 400 may include Tx beam 421, Tx beam 422, and Tx beam 425. The second set of Tx beams as illustrated in diagram 400 may include Tx beam 423 and Tx beam 424. The Tx beam 421, in some aspects, may be associated with a highest channel and/or signal quality based on a maximum Tx power. However, based on the location of a user's hand 440 along a beam direction 431 (but not along a beam direction 433 or beam direction 435), the Tx beam 421 may be associated with a reduced Tx power to avoid an MPE event for the user's hand 440.

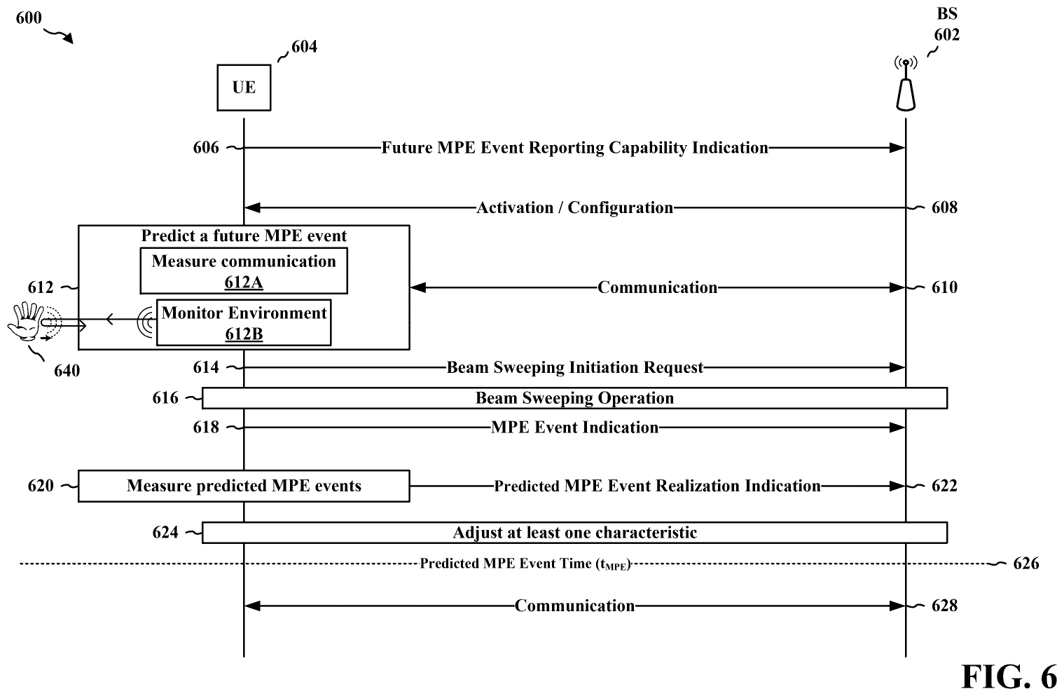

For example, for a first (scheduled) communication associated with a large amount of UL data transmitted via the Tx beam 421, the UE 404 may determine that the Tx power associated with the first communication exceeds an MPE threshold and initiate a mitigation operation that may, in some aspects, result in reducing a Tx power associated with the first communication, or selecting alternative resources (e.g., carriers or beams) for transmitting at least a portion of the first communication. Based on the reduced Tx power, the Tx beam 421 may no longer have a highest channel and/or signal quality among the Tx beams (e.g., Tx beams 421-425) in the first and second set of beams. Accordingly, one or more of Tx beam 422, Tx beam 423, Tx beam 424, or Tx beam 425 may be associated with a highest channel and/or signal quality at a maximum Tx power allowed at the Tx beams 422-425. FIG. 6 below discusses the response of a UE such as UE 404 to detecting an MPE event associated with at least one beam direction and/or component carrier.

In some aspects, a wireless device may include a radar product solution, e.g., implemented in a radar device 301 (e.g., as a chipset, etc.), using the 60 GHZ unlicensed band to perform range and/or angle tracking. Using the wide bandwidth associated with the 60 GHz band, in some aspects, may enable high accuracy and resolution for the radar ranging and/or angle tracking. In some aspects, the radar device 301 may enable multiple applications such as one or more of proximity sensing, location sensing, gesture recognition, velocity sensing, or proximity prediction. In some aspects, the radar device 301 may further enable a future MPE event prediction based on sensing one or more of the location of an object, the velocity of the object, and/or the proximity (range) of the object. For example, by object tracking, the radar device 301 may estimate that a first object currently beyond a threshold distance from the Tx antenna or radar device 301 may be expected to be closer than the threshold distance at a future time. A scheduled transmission associated with the future time may then be assessed to determine whether it is associated with a predicted future MPE event at the future time when the object is predicted to be within the threshold distance.

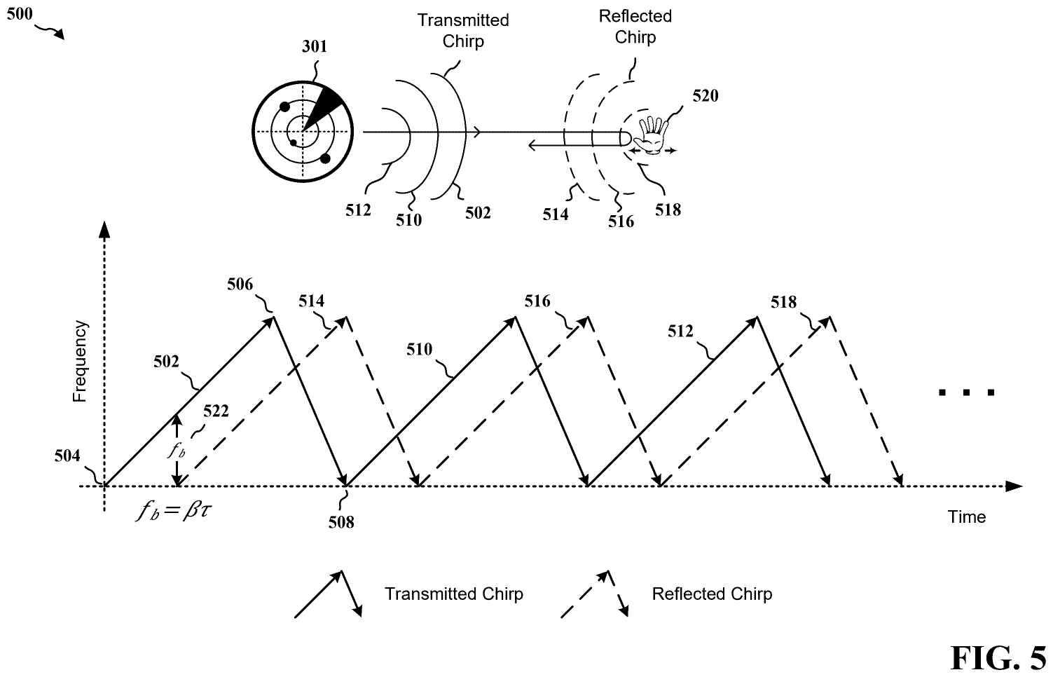

Example aspects of radar detection are described in connection with FIG. 5 below. A radar component 301, which may also be referred to as a radar device, as described in connection with FIG. 3, may transmit a radar transmission (e.g., which may also be referred to as radar waves, radar waveform, radar pulses, and/or radar signals, etc.) and measure reflections of the radar transmission to detect physical objects or physical surrounding. FIG. 5 is a diagram 500 illustrating an example of FMCW signals generated from a radar device 301 (e.g., an FMCW radar) that may be used to measure for a beam blockage in accordance with various aspects of the present disclosure. The radar device 301 may detect an object 520 (e.g., a human hand) by transmitting a set of radar transmissions, which may be a set of chirp signals (or may also be referred to as a pulse signals), where each of the chirp signals may have a frequency that varies linearly (e.g., have a frequency sweeping) over a fixed period of time (e.g., over a sweep time) by a modulating signal. For example, as shown by the diagram 500, a transmitted chirp 502 may have a starting frequency at 504 of a sinusoid. Then the frequency may be gradually (e.g., linearly) increased on the sinusoid until it reaches the highest frequency at 506 of the sinusoid, and then the frequency of the signal may return to 508 and another chirp 510 may be transmitted in the same way. In other words, each chirp may include an increase in the frequency (e.g., linearly) and a drop in the frequency, such that the radar device 301 may transmit chirps sweeping in frequency.

After one or more chirps (e.g., chirps 502, 510, 512, etc.) are transmitted by the radar device 301, the transmitted chirps may reach the object 520 and reflect back to the radar device 301, such as shown by the reflected chirps 514, 516, and 518, which may correspond to the transmitted chirps 502, 510, and 512, respectively. As there may be a distance between the radar device 301 and the object 520 and/or it may take time for a transmitted chirp to reach the object 520 and reflect back to the radar device 301, a delay may exist between a transmitted chirp and its corresponding reflected chirp. The delay may be proportional to a range between the radar device 301 and the object 520 (e.g., the further the target, the larger the delay and vice versa). Thus, the radar device 301 may be able to measure or estimate a distance between the radar device 301 and the object 520 based on the delay. However, in some examples, it may not be easy for some devices to measure or estimate the distance based on the delay between a transmitted chirp and a reflected chirp.

In other examples, as an alternative, the radar device 301 may measure a difference in frequency between the transmitted chirp and the reflected chirp, which may also be proportional to the distance between the radar device 301 and the object 520. In other words, as the frequency difference between the reflected chirp and the transmitted chirp increases with the delay, and the delay is linearly proportional to the range, the distance of the object 520 from the radar device 301 may also be determined based on the difference in frequency. Thus, the reflected chirp from the object may be mixed with the transmitted chirp and down-converted to produce a beat signal (f_{b}) which may be linearly proportional to the range after demodulation. For example, the radar device 301 may determine a beat signal 522 by mixing the transmitted chirp 502 and its corresponding reflected chirp 514. In some examples, a radar device may also be used to detect the velocity and direction of a using the FMCW. For example, an FMCW receiver may be able to identify the beat frequency/range based on a range spectrum. The FMCW receiver may also be able to identify the velocity based on a Doppler spectrum and/or the direction based on a direction of arrival (DoA) spectrum with multiple chirps. In some aspects, the radar device 301 may determine a range and a velocity based on a short burst transmission at a single frequency (e.g., a ping). For example, the radar device 301 may determine a range to the object 520 based on a timing of receiving a reflected transmission and may determine a velocity of the object 520 based on a frequency of the reflected transmission received at the radar device 301 (e.g., a change in frequency from the transmitted frequency).

FIG. 6 is a call flow diagram 600 illustrating a UE 604 in communication with a base station 602 in accordance with some aspects of the disclosure. While FIG. 6 illustrates a communication between a UE and a base station, the devices in communication are not limited to a UE and a base station but may include wireless devices and network nodes that monitor for MPE events and/or respond to reported MPE events generally. In some aspects, the UE 604 may transmit, and the base station 602 may receive, a future MPE event reporting capability indication 606 that indicates that the UE may be configured to report predicted future MPE events. The future MPE event reporting capability indication 606, in some aspects, may further indicate a maximum number of beams for which future MPE events can be predicted by the UE 604. In some aspects, the future MPE event reporting capability indication 606 may be provided as part of an initial access operation, via RRC signaling, or via a MAC-CE.

In response to the future MPE event reporting capability indication 606, the base station 602 may transmit, and the UE 604 may receive, an activation and/or configuration 608 activating and/or configuring the UE 604 to predict and/or report predicted future MPE events. For example, the base station 602 may activate a capacity to predict future MPE events and/or may configure a set of parameters associated with reporting predicted future MPE events. The set of parameters may include a threshold confidence value for reporting a predicted future MPE event, a number of beams and/or carriers for which to enable and/or activate predicted future MPE event reporting. In some aspects, the activation and/or configuration 608 may be provided as part of an initial access operation, via RRC signaling, via a MAC-CE, or via DCI.

The UE 604 and the base station 602 may exchange communication 610. The communication 610 may include DL and UL transmissions and associated control information, e.g., RRC signaling, MAC-CE, DCI, and/or UCI. The control information associated with one or more UL transmissions may include information relating to UL grants and/or scheduled UL transmissions. The UE 604, in some aspects, may predict a future MPE event at 612. In some aspects, predicting the future MPE event at 612 may include measuring, at 612A, the communication 610. Measuring, at 612A, the communication 610, in some aspects, may include determining a power to be used for a transmission via resources indicated in a UL grant or for a scheduled UL transmission. The determined power may be based on an amount of information to be transmitted via the resources indicated in the UL grant or for a scheduled UL transmission. The power measured and/or determined by measuring the communication at 612 may be a per beam and/or a per carrier measured and/or determined power.

In some aspects, predicting the future MPE event at 612 may include monitoring, at 612B, an environment of the UE 604. For example, the UE 604 (or a radar device of the UE 604) may transmit radar signals (e.g., radar signals 502, 510, and/or 512 of FIG. 5) to detect an object (e.g., human hand 640). As described in relation to FIG. 5, detecting an object as part of monitoring, at 612B, the environment of the UE 604 may include determining a location of the object (e.g., a distance and angle to the object) and a velocity of the object. The location and velocity information may allow the UE 604 to predict a future time at which the object may enter a near-field area and be associated with an MPE threshold.

In some aspects, by combining the power measured and/or determined by measuring the communication at 612 at a first future time (or during a first future time period) and a prediction that an object may enter a near-field area at the first future time (or during the first future time period), the UE 604 may predict, at 612, a future MPE event. In some aspects, the future MPE event predicted at 612 may be associated with a confidence value indicating a calculated confidence in (e.g., a likelihood of) the prediction. A predicted future MPE event, in some aspects, may be reported when a confidence measure (e.g., a calculated confidence value) is above a threshold confidence measure. In some aspects, the threshold confidence measure may be a known threshold value or a configured threshold value (e.g., by the activation and/or configuration 608 as described above).

The confidence may be based on a first probability of an amount of information to be transmitted exceeding a threshold associated with the MPE threshold and a second probability of the object (e.g., a human body part) entering an exposure area (e.g., a near-field area) during the transmission with a power exceeding the MPE threshold. For example, the first probability of the amount of information to be transmitted exceeding the threshold associated with the MPE threshold may be based on an amount of data expected and/or predicted to be generated by a process executing on the UE 604. The second probability of the object entering an exposure area during the transmission with a power exceeding the MPE threshold may be based on a distance from the exposure area, a direction of a movement of the object, a speed of the movement of the object and a likelihood of a change of the direction or the speed (e.g., based on a configured set of assumptions and/or based on a set of historical measurements based on the monitoring at 612B).

In some aspects, predicting, at 612, the future MPE event may also include measuring a current MPE event. For example, if the object is currently detected in the exposure area and the measured and/or detected power of a current UL transmission (e.g., a UL transmission scheduled within a first time period from a current time) is above an MPE threshold, the UE 604 may identify a current, measured MPE event. The UE 604 may include the measured (current) MPE event in a subsequent MPE event report.

In some aspects, the UE 604 may determine, based on the measurement, at 612A, that a currently-used beam is associated with a predicted future MPE event. If the UE 604 has not identified an alternate beam for the UL transmission associated with the predicted future MPE event, the UE 604 may transmit, and the base station 602 may receive a beam sweeping initiation request 614. Based on the beam sweeping initiation request 614, the UE 604 and the base station 602 may perform a beam sweeping operation 616 to identify at least one alternative Tx beam for UL transmissions from the UE 604. In some aspects, the beam sweeping operation 616 may not be necessary based on a previously-conducted beam sweeping operation.

The UE 604, in some aspects may transmit, and the base station 602 may receive, an MPE event indication 618 related to the future MPE event predicted at 612. The indication may be comprised in an MPE report, for example. In some aspects, the MPE event indication 618 related to the predicted future MPE event may include a future timestamp associated with the predicted future MPE event. The future timestamp, in some aspects, may indicate a time at which a change to a P-MPR based on the predicted future MPE event takes effect.

In some aspects, the MPE event indication 618 related to the predicted future MPE event is transmitted in a report that indicates multiple MPE events. In some aspects, the MPE event indication 618 may include, or be, a report identifying one or more of a particular component carrier or a particular beam associated with each of the multiple MPE events. A calculated confidence value for each MPE event included in the MPE event indication 618, in some aspects, may be included in the MPE event indication 618. The MPE event indication 618, in some aspects, may indicate one or more of a plurality of component carriers or one or more of a plurality of beams for which the future MPE event is predicted to occur. In some aspects, the plurality of component carriers or the plurality of beams may be indicated based on a group to which the plurality of component carriers or the plurality of beams belongs.

In some aspects, MPE event indication 618 may include an additional indication of a measured (e.g., current) MPE event. The additional indication, in some aspects, may indicates that the measured MPE event is a measured (current) MPE event. The MPE event indication 618, in some aspects, may indicate at least one of a predicted power headroom or an UL RSRP at a predicted time of the future MPE event based on at least one of a path loss prediction or the predicted future MPE event. In some aspects, the MPE event indication 618 may indicate one or more of a recommended beam (e.g., based on a known alternative beam or an alternative beam identified by beam sweeping operation 616), a recommended modulation and coding scheme (MCS), or a recommended number of uplink layers associated with the predicted future MPE event. For example, the UE may report a proposed uplink beam, or set of one or more beam candidates to replace a current beam in response to the predicted MPE event. The UE may report a proposed communication parameter, e.g., such as an MCS, number of uplink layers, etc., to replace a current communication parameter for uplink transmission in response to the predicted MPE event. The recommended beam in the MPE event indication 618, in some aspects, may be a beam that is different from a currently-used beam associated with the predicted future MPE event, and the recommended beam is based on the beam sweeping operation 616 initiated based on the beam sweeping initiation request 614. The future timestamp, in some aspects, may indicate a time at which the recommended beam, MCS, or number of MIMO layers based on the predicted future MPE event takes effect (e.g., a time at which the UE 604 and the base station 602 will transmit and receive, respectively, based on the recommendation).

At 620, the UE 604 may measure the predicted future MPE event. In some aspects, measuring the predicted future MPE event at 620 may include measuring and/or determining characteristics of a communication associated with the future timestamp (e.g., associated with a time indicated by the future timestamp) associated with the predicted future MPE event. Measuring, at 620, the characteristics of the communication associated with the future timestamp, in some aspects, may include determining a power associated with a transmission via resources indicated in a UL grant or for a scheduled UL transmission associated with the future timestamp, where the determined power may be based on an amount of information to be transmitted via the resources indicated in the UL grant or for a scheduled UL transmission associated with the future timestamp. Measuring, at 620, the characteristics of the communication associated with the future timestamp, in some aspects, may include monitoring an environment of the UE to determine if a predicted proximity of a human body part (e.g., human hand 640) is realized at the time associated with the future timestamp

The UE 604 may transmit, and the base station 602 may receive, a predicted MPE event realization indication 622 indicating that the predicted future MPE event has become a measured MPR event. The prediction-realization indication, in some aspects, indicates whether the predicted MPE event is detected based on the characteristics measured at 620. The predicted MPE event realization indication 622 may indicate for the base station 602 to implement a recommended adjustment and/or update to a configuration of the communication between the UE 604 and the base station 602.

In some aspects, the UE 604 and base station 602 may adjust, at 624, at least one characteristic of a communication between the UE 604 and the base station 602 based on the indication of the predicted future MPE event. The at least one characteristic of the communication, in some aspects, may be adjusted based on a timeline that starts from the transmission of the indication of the predicted future MPE event, or a reception of an acknowledgment of the indication. In some aspects, the timeline may have a length based on at least one of a timing indicated for the future MPE event or a time threshold. The time threshold, in some aspects, may be based on a minimum time for the UE 604 and the base station 602 to adjust the characteristics (e.g., a configuration). The at least one characteristic, in some aspects, may be a beam, an MCS, or a number of MIMO layers for a UL transmission associated with the predicted future MPE event. In some aspects, adjusting, at 624, the at least one characteristic of a communication between the UE 604 and the base station 602 may be performed such that the adjustment is complete before a predicted MPE event time 626. After updating the at least one characteristic at 624, the UE 604 and the base station 602 may engage in communication 628.

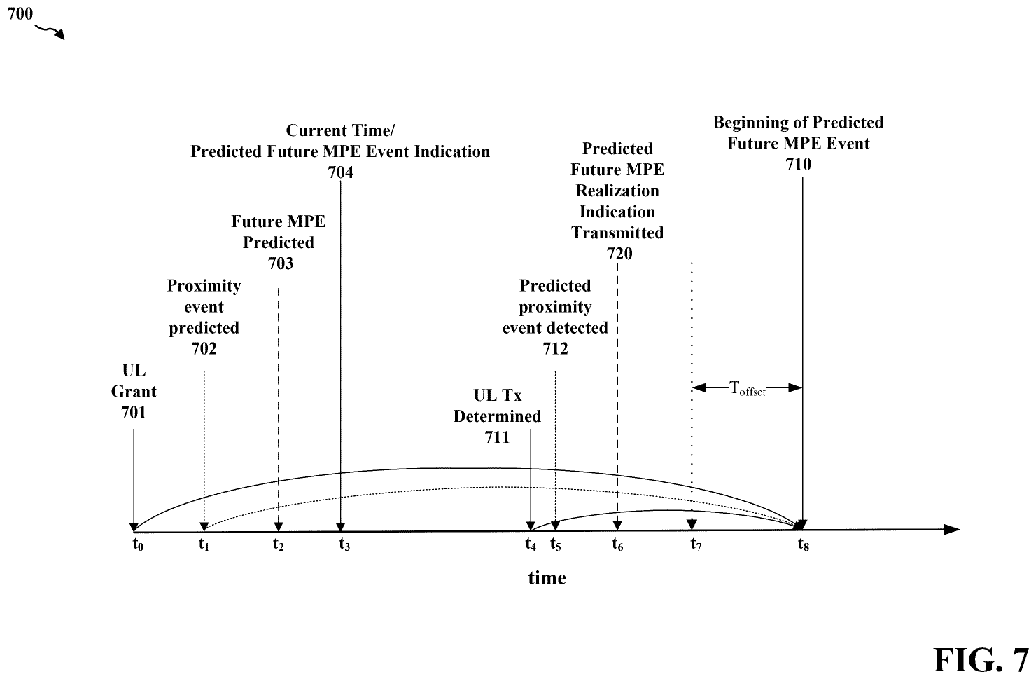

FIG. 7 is a diagram 700 illustrating a timeline associated with a prediction of a future MPE event in accordance with some embodiments. The timeline may begin at a time to associated with receiving an indication of a configured UL grant 701 and/or a set of scheduled UL resources for a time t₈ associated with the beginning of a future MPE event 710 predicted at t₂. The UL grant 701 may be associated with an amount of resources that, if used, would have a total power that is greater than an MPE threshold. Determining that the UL grant 701 may be associated with an MPE event may correspond to measuring the communication 610 at 612A. at a second time t₁ the UE may predict, e.g., based on monitoring the environment of the UE 604 at 612B, a proximity event 702 (e.g., that a human body part is predicted to enter a near-field, or exposure, area). Based on the UL grant 701 and the predicted proximity event 702, the UE may predict, at t₂, a future MPE event 703 at a time t₈. An indication of the predicted future MPE event 704 may be transmitted at the time t₃, where the indication of the predicted future MPE event 704 may include the information as described in relation to MPE event indication 618 of FIG. 6.

At a later time t₄, the UE may determine 711 which, or how many, of the resources indicated in the UL grant 701 will be used for a UL transmission at time to. The UE may also detect the predicted proximity event 712 at the time t₈ and the UE may determine that the predicted future MPE event will be realized and transmit a predicted future MPE event realization indication 720 at time t₆. The time to, in some aspects, may precede a cutoff time t₇ for reconfiguring communication characteristics before the predicted (and realized) future MPE event occurs at time to. The timing of an adjustment to communication characteristics (e.g., as described in relation to 624 of FIG. 6) may be based on a configured offset time (T_{offset}) and the predicted (and indicated) beginning of a future MPE event at time to.

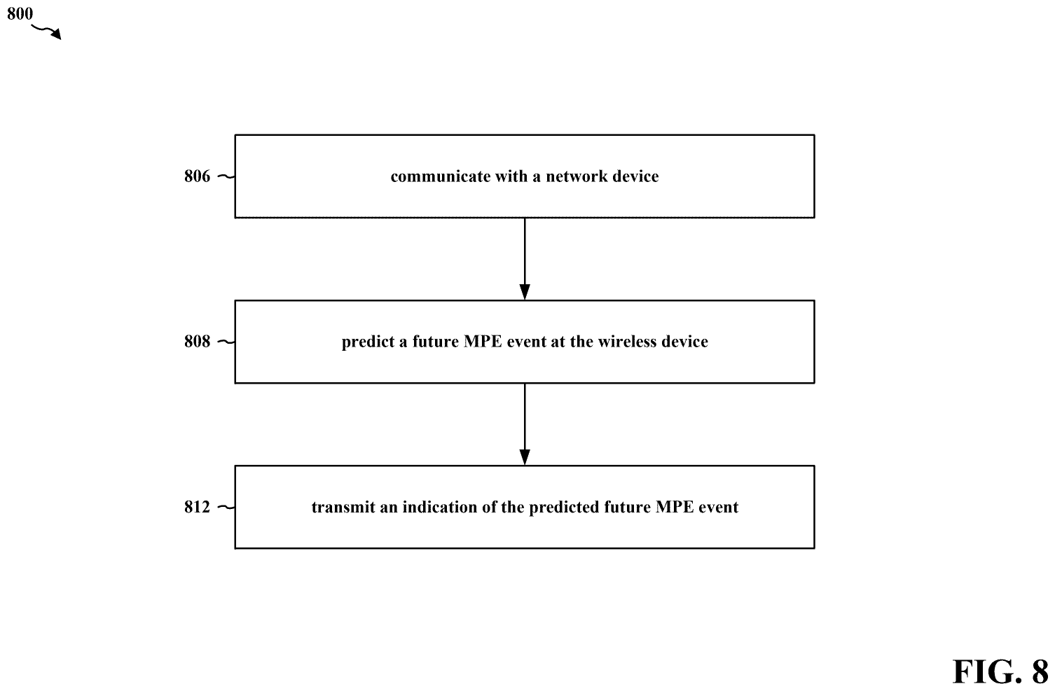

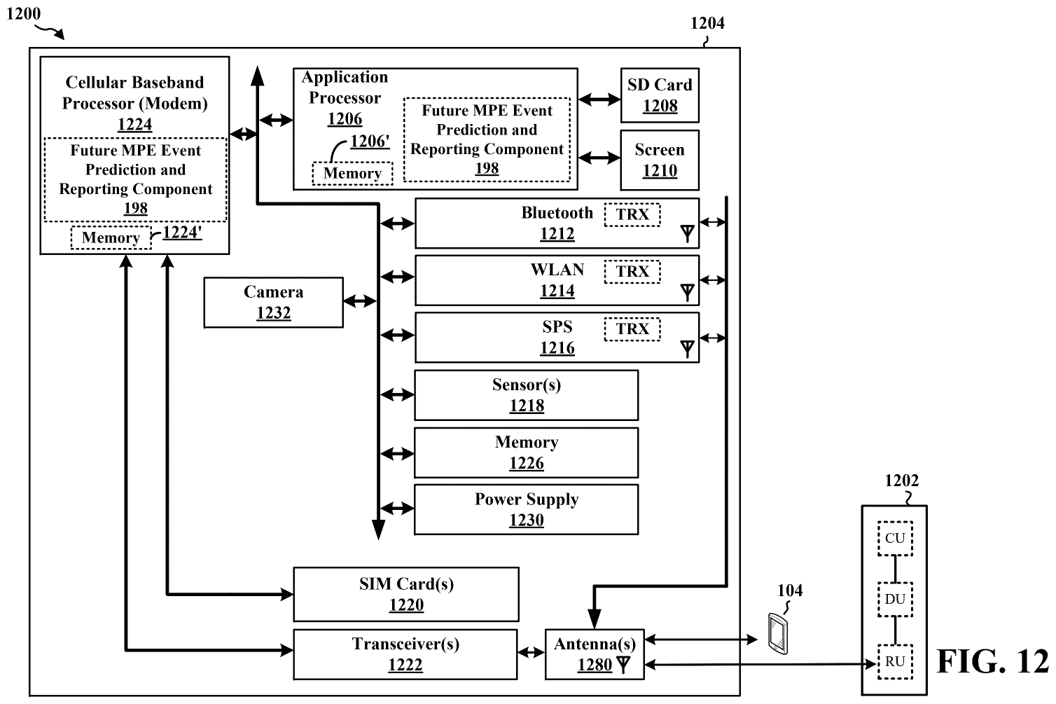

FIG. 8 is a flowchart 800 of a method of wireless communication. The method may be performed by a wireless device such as a UE (e.g., the UE 104, 404, or 604; the apparatus 1204). At 806, the UE may communicate with the network node (e.g., a base station or other network device). For example, 806 may be performed by application processor 1206, cellular baseband processor 1224, transceiver(s) 1222, antenna(s) 1280, and/or future MPE event prediction and reporting component 198 of FIG. 12. The communication may include both DL transmissions and UL transmissions. The UL transmissions may be subject to MPE limits. For example, referring to FIG. 6, the UE 604 and the base station 602 may exchange communication 610.

Prior to, or during the communication at 806, the UE may transmit a capability indication indicating that the wireless device can predict a future MPE event. The capability indication, in some aspects, may be transmitted for a network node (e.g., a base station or other network device) and may be included in an initial access process or may be transmitted via RRC signaling. In some aspects, the capability indication indicates a maximum number of beams for which future MPE events can be predicted by the wireless device. For example, referring to FIG. 6, the UE 604 may transmit, and the base station 602 may receive, future MPE event reporting capability indication 606 indicating the capacity to predict future MPE events and, in some aspects, an indication of a maximum number of beams for which future MPE events may be predicted.

Based on the capability indication, the UE may receive an activation indication indicating for the wireless device to predict one or more future MPE events. The activation indication, in some aspects, may be received from a network node (e.g., a base station) that receives the capability indication. The activation indication, in some aspects, may also include configuration information regarding a maximum number of beams for which to predict future MPE events and configuration information for reporting predicted future MPE events. The report configuration, in some aspects, may include a threshold confidence value for reporting a predicted future MPE event. The threshold confidence value may be used to determine whether to send an indication (or report) for a predicted future MPE event, where the indication of the predicted future MPE event is transmitted by the UE and received by the base station when the confidence measure is above a threshold confidence value. In some aspects, the activation indication may be transmitted via RRC signaling. For example, referring to FIG. 6, the UE 604 may receive, and base station 602 may transmit, activation and/or configuration 608 indicating for the UE 604 to enable future MPE event prediction and, in some aspects, to configure the prediction at, and/or the reporting from, the UE 604.

The UE may be responsible, in some aspects, for monitoring Tx power and a proximity of a human (or a body part of a human) to enforce the MPE limits (e.g., an MPE threshold). The UE may enforce the MPE limits in conjunction with the network node by reporting MPE events associated with scheduled UL transmissions and/or UL resource grants for the network node to reconfigure the scheduled UL transmissions or UL resource grants to comply with the MPE limits. Accordingly, at 808, the UE may predict a future MPE event. For example, 808 may be performed by application processor 1206, cellular baseband processor 1224, one or more of sensor modules 1218 (e.g., a radar module), and/or future MPE event prediction and reporting component 198 of FIG. 12. The predicted future MPE event, in some aspects, may be associated with a first time in the future (e.g., a time at which the predicted future MPE event will occur or a time at which a mitigation operation is indicated for avoiding or preventing the predicted future MPE event). In some aspects, the UE may also monitor for measured (current) MPE events. A measured MPE event, in some aspects, may be distinguished from a predicted future MPE event in one or more of the following ways: (1) a measured MPE event may be associated with a human body part that is currently within an exposure area of a Tx antenna while a predicted future MPE event may be associated with a human body part that is predicted to move into the exposure area of the Tx antenna at a future time or (2) a measured MPE event may be associated with a scheduled UL transmission within a first threshold time from a current time while the predicted future MPE event may be associated with a scheduled UL transmission that is predicted to occur after the first threshold time from a current time.

In some aspects, predicting the future MPE event at 808 may include (1) determining a power associated with a transmission via resources indicated in a UL grant or for a scheduled UL transmission and/or (2) monitoring an environment of the UE. In some aspects, predicting the future MPE event may include calculating a confidence measure associated with the predicted future MPE event. The calculated confidence measure may be used to determine whether the predicted future MPE event is a reportable future MPE event (e.g., whether the calculated measure is above a configured threshold confidence value triggering a report or indication transmission). For example, referring to FIG. 6, the UE 604 may predict a future MPE event at 612. In some aspects, predicting the future MPE event at 612 may include measuring, at 612A, the communication 610 and monitoring, at 612B, an environment of the UE 604 as discussed above.

In some aspects, the UE may, based on the predicted future MPE event transmit a request to initiate a beam sweeping operation to identify a replacement beam (e.g., an alternative beam). The request may be transmitted, in some aspects, in order to determine an alternative to a currently used beam to include in a report or indication of the predicted future MPE event for the network node. For example, referring to FIG. 6, the UE 604 may transmit, and base station 602 may receive, the beam sweeping initiation request 614. As discussed above, a beam sweeping operation 616 may then be performed to allow the UE 604 to identify one or more candidate alternative or replacement beams for the currently used beam.

At 812, the UE may transmit an indication of the predicted future MPE event predicted at 808 for the network node. For example, 812 may be performed by application processor 1206, cellular baseband processor 1224, transceiver(s) 1222, antenna(s) 1280, and/or future MPE event prediction and reporting component 198 of FIG. 12. The indication of the predicted future MPE event, in some aspects, includes a future timestamp associated with the predicted future MPE event. The future timestamp, in some aspects, may indicate a time at which a change to a P-MPR based on the predicted MPE event takes effect. For example, the first time in the future may be indicated as a time at which a change to the P-MPR takes effect, or a time associated with the beginning of the predicted future MPE event such that the P-MPR takes effect at a time that precedes the first time in the future by a configured time offset (e.g., a time offset configured to allow any mitigating operation to be complete before the first future time). In some aspects, a confidence measure for a predicted future MPE event that was calculated when making the prediction may be associated with the indication of the predicted future MPE event, while in some aspects the indication of the predicted future MPE event is based on the calculated confidence measure being above a threshold confidence value as discussed above.

In some aspects, the indication of the predicted future MPE event may be transmitted in a report that indicates multiple MPE events (e.g., one or more predicted future MPE events and/or measured MPE events). In some aspects enabling reporting for multiple component carriers and/or beams, the report identifies one or more of a particular component carrier or a particular beam for each of the multiple MPE events. The indication of the predicted future MPE event, in some aspects, may indicate one or more of a plurality of component carriers (e.g., associate with CA) or one or more of a plurality of beams (e.g., beams associated with a same TRP and/or beam group) for which the future MPE event is predicted to occur. The plurality of component carriers and/or the plurality of beams, in some aspects, may be indicated based on a group to which the plurality of component carriers or the plurality of beams belongs.

The indication of the predicted future MPE event, in some aspects, may indicate at least one of a predicted power headroom or an UL RSRP at a predicted time of the future MPE event based on at least one of a path loss prediction or the predicted future MPE event. The indication of the predicted future MPE event, in some aspects, may indicate one or more of a recommended beam (e.g., based on a beam sweeping operation initiated by the request at 810), a recommended MCS, or a recommended number of MIMO layers for the UL transmission. For example, referring to FIG. 6, the UE 604 may transmit, and the base station 602 may receive, the MPE event indication 618.

In some aspects, the UE may transmit, an additional indication of a measured MPE event. The additional indication of the measured MPE event, in some aspects, may indicate that the measured MPE event is a measured MPE event as opposed to a predicted future MPE event, e.g., by including a future timestamp value of ‘0’ or other value that is used to identify a current measured MPE event. For example, referring to FIG. 6, the UE 604 may transmit, and the base station 602 may receive, the MPE event indication 618 that includes an additional indication of a measured MPE event.

The UE 604, in some aspects, may measure characteristics of the communication with the network node based on the future timestamp associated with the predicted MPE event. In some aspects, measuring the characteristics of the communication with the network node based on the future timestamp associated with the predicted MPE event may include measuring and/or determining characteristics of a communication associated with the future timestamp (e.g., associated with a time indicated by the future timestamp). Measuring the characteristics of the communication associated with the future timestamp, in some aspects, may include determining a power associated with a transmission via resources indicated in a UL grant or for a scheduled UL transmission associated with the future timestamp, where the determined power may be based on an amount of information to be transmitted via the resources indicated in the UL grant or for a scheduled UL transmission associated with the future timestamp. Measuring the characteristics of the communication associated with the future timestamp, in some aspects, may include monitoring an environment of the UE to determine if a predicted proximity of a human body part is realized at the time associated with the future timestamp. For example, referring to FIG. 6, the UE 604 may measure, at 620, the predicted future MPE event.

Based on the characteristics measured at 808, the UE, in some aspects, may transmit a prediction-realization indication indicating whether the predicted future MPE event is detected. The prediction-realization indication, in some aspects, may indicate that the predicted future MPE event has become a measured MPR event. The prediction-realization indication may indicate for the network node to implement a recommended adjustment and/or update to a configuration of the communication between the UE and the network node. Alternatively, if the prediction-realization indication indicates that the predicted future MPE event has not become a measured MPE event, the prediction-realization indication may indicate for the network node to not implement the recommended adjustment and/or update to a configuration of the communication between the UE and the network node. For example, if a human body part fails to enter into the exposure zone as predicted the predicted future MPE event may be indicated to not be realized and may further indicate for the recommended adjustment and/or update to a configuration of the communication between the UE and the network node to not be implemented (e.g. to be ignored). For example, referring to FIG. 6, the UE 604 may transmit, and base station 620 may receive, predicted MPE event realization indication 622 indicating that the predicted future MPE event has (or has not) become a measured MPR event.

Assuming that the prediction-realization indication indicates that the predicted future MPE event has become a measured MPR event, the UE may adjust at least one characteristic of a communication with the network device based on the indication of the predicted future MPE event. In some aspects, the at least one characteristic of the communication may be adjusted based on a timeline that starts from the transmission of the indication of the predicted future MPE event, or a reception of an acknowledgment of the indication. The timeline, in some aspects, may have a length based on at least one of a timing indicated for the predicted future MPE event or a time threshold (e.g., an amount of time before an indicated future time associated with the predicted future MPE event). For example, referring to FIG. 6, the UE 604 and the base station 602 may adjust, at 624, at least one characteristic of a communication between the UE 604 and the base station 602 based on the indication of the predicted future MPE event included in MPE event indication 618.

Finally, the UE may communicate with the network node using the at least one characteristic adjusted based on the indication of the predicted future MPE event. The communication, in some aspects, may be based on one or more of an adjusted beam, MCS, or number of MIMO layers for a UL transmission associated with the predicted future MPE event. For example, referring to FIG. 6, the UE 604 and the base station 602 may engage in communication 628 based on the at least one characteristic adjusted at 624.

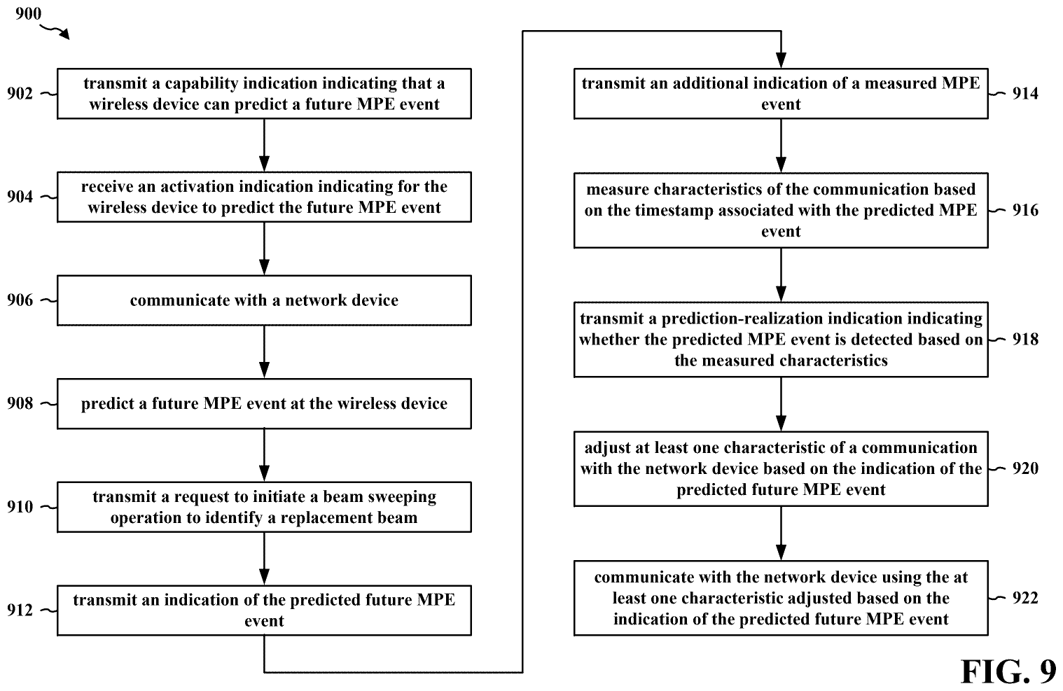

FIG. 9 is a flowchart 900 of a method of wireless communication. The method may be performed by a wireless device such as a UE (e.g., the UE 104, 404, or 604; the apparatus 1204). At 902, the UE may transmit a capability indication indicating that the wireless device can predict a future MPE event. For example, 902 may be performed by application processor 1206, cellular baseband processor 1224, transceiver(s) 1222, antenna(s) 1280, and/or future MPE event prediction and reporting component 198 of FIG. 12. The capability indication, in some aspects, may be transmitted for a network node (e.g., a base station or other network device) and may be included in an initial access process or may be transmitted via RRC signaling. In some aspects, the capability indication indicates a maximum number of beams for which future MPE events can be predicted by the wireless device. For example, referring to FIG. 6, the UE 604 may transmit, and the base station 602 may receive, future MPE event reporting capability indication 606 indicating the capacity to predict future MPE events and, in some aspects, an indication of a maximum number of beams for which future MPE events may be predicted.

At 904, the UE may receive an activation indication indicating for the wireless device to predict one or more future MPE events. The activation indication, in some aspects, may be received from a network node (e.g., a base station) that receives the capability indication. For example, 904 may be performed by application processor 1206, cellular baseband processor 1224, transceiver(s) 1222, antenna(s) 1280, and/or future MPE event prediction and reporting component 198 of FIG. 12. The activation indication, in some aspects, may also include configuration information regarding a maximum number of beams for which to predict future MPE events and configuration information for reporting predicted future MPE events. The report configuration, in some aspects, may include a threshold confidence value for reporting a predicted future MPE event. The threshold confidence value may be used to determine whether to send an indication (or report) for a predicted future MPE event, where the indication of the predicted future MPE event is transmitted by the UE and received by the base station when the confidence measure is above a threshold confidence value. In some aspects, the activation indication may be transmitted via RRC signaling. For example, referring to FIG. 6, the UE 604 may receive, and base station 602 may transmit, activation and/or configuration 608 indicating for the UE 604 to enable future MPE event prediction and, in some aspects, to configure the prediction at, and/or the reporting from, the UE 604.

At 906, the UE may communicate with the network node (e.g., a base station or other network device). For example, 906 may be performed by application processor 1206, cellular baseband processor 1224, transceiver(s) 1222, antenna(s) 1280, and/or future MPE event prediction and reporting component 198 of FIG. 12. The communication may include both DL transmissions and UL transmissions. The UL transmissions may be subject to MPE limits. For example, referring to FIG. 6, the UE 604 and the base station 602 may exchange communication 610.

The UE may be responsible, in some aspects, for monitoring Tx power and a proximity of a human (or a body part of a human) to enforce the MPE limits (e.g., an MPE threshold). The UE may enforce the MPE limits in conjunction with the network node by reporting MPE events associated with scheduled UL transmissions and/or UL resource grants for the network node to reconfigure the scheduled UL transmissions or UL resource grants to comply with the MPE limits. Accordingly, at 908, the UE may predict a future MPE event. For example, 908 may be performed by application processor 1206, cellular baseband processor 1224, one or more of sensor modules 1218 (e.g., a radar module), and/or future MPE event prediction and reporting component 198 of FIG. 12. The predicted future MPE event, in some aspects, may be associated with a first time in the future (e.g., a time at which the predicted future MPE event will occur or a time at which a mitigation operation is indicated for avoiding or preventing the predicted future MPE event). In some aspects, the UE may also monitor for measured (current) MPE events. A measured MPE event, in some aspects, may be distinguished from a predicted future MPE event in one or more of the following ways: (1) a measured MPE event may be associated with a human body part that is currently within an exposure area of a Tx antenna while a predicted future MPE event may be associated with a human body part that is predicted to move into the exposure area of the Tx antenna at a future time or (2) a measured MPE event may be associated with a scheduled UL transmission within a first threshold time from a current time while the predicted future MPE event may be associated with a scheduled UL transmission that is predicted to occur after the first threshold time from a current time.

In some aspects, predicting the future MPE event at 908 may include (1) determining a power associated with a transmission via resources indicated in a UL grant or for a scheduled UL transmission and/or (2) monitoring an environment of the UE. In some aspects, predicting the future MPE event may include calculating a confidence measure associated with the predicted future MPE event. The calculated confidence measure may be used to determine whether the predicted future MPE event is a reportable future MPE event (e.g., whether the calculated measure is above a configured threshold confidence value triggering a report or indication transmission). For example, referring to FIG. 6, the UE 604 may predict a future MPE event at 612. In some aspects, predicting the future MPE event at 612 may include measuring, at 612A, the communication 610 and monitoring, at 612B, an environment of the UE 604 as discussed above.

In some aspects, the UE may, based on the predicted future MPE event transmit, at 910, a request to initiate a beam sweeping operation to identify a replacement beam (e.g., an alternative beam). For example, 910 may be performed by application processor 1206, cellular baseband processor 1224, transceiver(s) 1222, antenna(s) 1280, and/or future MPE event prediction and reporting component 198 of FIG. 12. The request may be transmitted at 910, in some aspects, in order to determine an alternative to a currently used beam to include in a report or indication of the predicted future MPE event for the network node. For example, referring to FIG. 6, the UE 604 may transmit, and base station 602 may receive, the beam sweeping initiation request 614. As discussed above, a beam sweeping operation 616 may then be performed to allow the UE 604 to identify one or more candidate alternative or replacement beams for the currently used beam.

At 912, the UE may transmit an indication of the predicted future MPE event predicted at 908 for the network node. For example, 912 may be performed by application processor 1206, cellular baseband processor 1224, transceiver(s) 1222, antenna(s) 1280, and/or future MPE event prediction and reporting component 198 of FIG. 12. The indication of the predicted future MPE event, in some aspects, includes a future timestamp associated with the predicted future MPE event. The future timestamp, in some aspects, may indicate a time at which a change to a P-MPR based on the predicted MPE event takes effect. For example, the first time in the future may be indicated as a time at which a change to the P-MPR takes effect, or a time associated with the beginning of the predicted future MPE event such that the P-MPR takes effect at a time that precedes the first time in the future by a configured time offset (e.g., a time offset configured to allow any mitigating operation to be complete before the first future time). In some aspects, a confidence measure for a predicted future MPE event that was calculated when making the prediction may be associated with the indication of the predicted future MPE event, while in some aspects the indication of the predicted future MPE event is based on the calculated confidence measure being above a threshold confidence value as discussed above.

In some aspects, the indication of the predicted future MPE event may be transmitted in a report that indicates multiple MPE events (e.g., one or more predicted future MPE events and/or measured MPE events). For example, a single MPE report from the UE may include information for multiple MPE events. In some aspects enabling reporting for multiple component carriers and/or beams, the report identifies one or more of a particular component carrier or a particular beam for each of the multiple MPE events. The indication of the predicted future MPE event, in some aspects, may indicate one or more of a plurality of component carriers (e.g., associate with CA) or one or more of a plurality of beams (e.g., beams associated with a same TRP and/or beam group) for which the future MPE event is predicted to occur. The plurality of component carriers and/or the plurality of beams, in some aspects, may be indicated based on a group to which the plurality of component carriers or the plurality of beams belongs.

The indication of the predicted future MPE event, in some aspects, may indicate at least one of a predicted power headroom or an UL RSRP at a predicted time of the future MPE event based on at least one of a path loss prediction or the predicted future MPE event. The indication of the predicted future MPE event, in some aspects, may indicate one or more of a recommended beam (e.g., based on a beam sweeping operation initiated by the request at 910), a recommended MCS, or a recommended number of MIMO layers for the UL transmission. For example, referring to FIG. 6, the UE 604 may transmit, and the base station 602 may receive, the MPE event indication 618.

In some aspects, the UE may transmit, at 914, an additional indication of a measured MPE event. For example, 914 may be performed by application processor 1206, cellular baseband processor 1224, transceiver(s) 1222, antenna(s) 1280, and/or future MPE event prediction and reporting component 198 of FIG. 12. The additional indication of the measured MPE event, in some aspects, may indicate that the measured MPE event is a measured MPE event as opposed to a predicted future MPE event, e.g., by including a future timestamp value of ‘0’ or other value that is used to identify a current measured MPE event. For example, referring to FIG. 6, the UE 604 may transmit, and the base station 602 may receive, the MPE event indication 618 that includes an additional indication of a measured MPE event.

The UE 604, in some aspects, may measure characteristics of the communication with the network node based on the future timestamp associated with the predicted MPE event at 916. For example, 916 may be performed by application processor 1206, cellular baseband processor 1224, one or more of sensor modules 1218 (e.g., a radar module), and/or future MPE event prediction and reporting component 198 of FIG. 12. In some aspects, measuring the characteristics of the communication with the network node based on the future timestamp associated with the predicted MPE event at 916 may include measuring and/or determining characteristics of a communication associated with the future timestamp (e.g., associated with a time indicated by the future timestamp). Measuring, at 916, the characteristics of the communication associated with the future timestamp, in some aspects, may include determining a power associated with a transmission via resources indicated in a UL grant or for a scheduled UL transmission associated with the future timestamp, where the determined power may be based on an amount of information to be transmitted via the resources indicated in the UL grant or for a scheduled UL transmission associated with the future timestamp. Measuring, at 916, the characteristics of the communication associated with the future timestamp, in some aspects, may include monitoring an environment of the UE to determine if a predicted proximity of a human body part is realized at the time associated with the future timestamp. For example, referring to FIG. 6, the UE 604 may measure, at 620, the predicted future MPE event.

Based on the characteristics measured at 908, the UE, in some aspects, may transmit, at 918, a prediction-realization indication indicating whether the predicted future MPE event is detected. For example, 918 may be performed by application processor 1206, cellular baseband processor 1224, transceiver(s) 1222, antenna(s) 1280, and/or future MPE event prediction and reporting component 198 of FIG. 12. The prediction-realization indication, in some aspects, may indicate that the predicted future MPE event has become a measured MPR event. The prediction-realization indication may indicate for the network node to implement a recommended adjustment and/or update to a configuration of the communication between the UE and the network node. Alternatively, if the prediction-realization indication indicates that the predicted future MPE event has not become a measured MPE event, the prediction-realization indication may indicate for the network node to not implement the recommended adjustment and/or update to a configuration of the communication between the UE and the network node. For example, if a human body part fails to enter into the exposure zone as predicted the predicted future MPE event may be indicated to not be realized and may further indicate for the recommended adjustment and/or update to a configuration of the communication between the UE and the network node to not be implemented (e.g. to be ignored). For example, referring to FIG. 6, the UE 604 may transmit, and base station 602 may receive, predicted MPE event realization indication 622 indicating that the predicted future MPE event has (or has not) become a measured MPR event.

Assuming that the prediction-realization indication indicates that the predicted future MPE event has become a measured MPR event, the UE may at 920, adjust at least one characteristic of a communication with the network device based on the indication of the predicted future MPE event. For example, 920 may be performed by application processor 1206, cellular baseband processor 1224, one or more of sensor modules 1218 (e.g., a radar module), and/or future MPE event prediction and reporting component 198 of FIG. 12. In some aspects, the at least one characteristic of the communication may be adjusted based on a timeline that starts from the transmission of the indication of the predicted future MPE event, or a reception of an acknowledgment of the indication. The timeline, in some aspects, may have a length based on at least one of a timing indicated for the predicted future MPE event or a time threshold (e.g., an amount of time before an indicated future time associated with the predicted future MPE event). For example, referring to FIG. 6, the UE 604 and the base station 602 may adjust, at 624, at least one characteristic of a communication between the UE 604 and the base station 602 based on the indication of the predicted future MPE event included in MPE event indication 618.

Finally, at 922, the UE may communicate with the network node using the at least one characteristic adjusted at 920 based on the indication of the predicted future MPE event. For example, 922 may be performed by application processor 1206, cellular baseband processor 1224, transceiver(s) 1222, antenna(s) 1280, and/or future MPE event prediction and reporting component 198 of FIG. 12. The communication at 922, in some aspects, may be based on one or more of an adjusted beam, MCS, or number of MIMO layers for a UL transmission associated with the predicted future MPE event. For example, referring to FIG. 6, the UE 604 and the base station 602 may engage in communication 628 based on the at least one characteristic adjusted at 624.

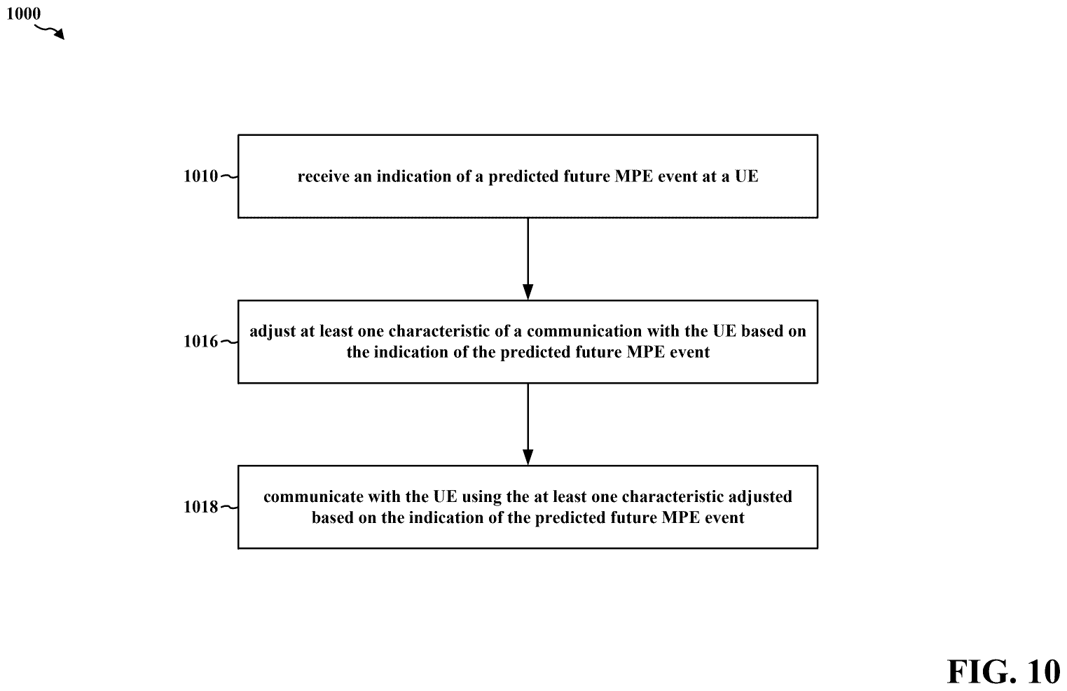

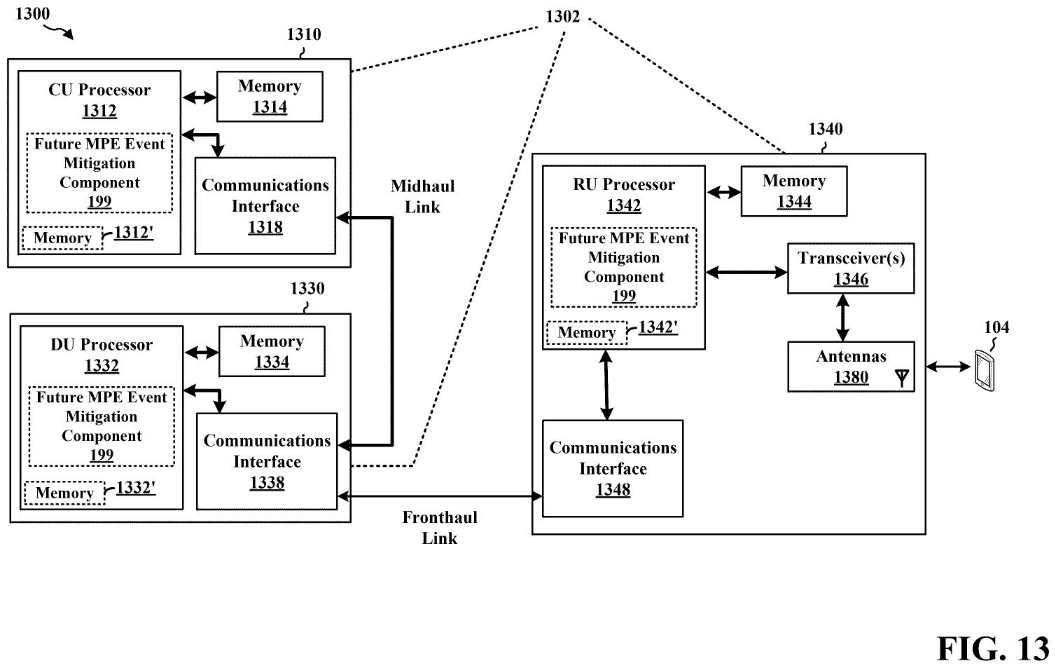

FIG. 10 is a flowchart 1000 of a method of wireless communication. The method may be performed by a network node such as a base station (e.g., the base station 102 402, 602; the network entity 1302). At 1010, the base station may receive an indication of a predicted future MPE event. For example, 1010 may be performed by CU processor 1312, DU processor 1332, RU processor 1342, network processor 1312, transceiver(s) 1346, antennas 1380, and/or future MPE event mitigation component 199 of FIG. 13. The indication of the predicted future MPE event, in some aspects, includes a future timestamp associated with the predicted future MPE event. The future timestamp, in some aspects, may indicate a time at which a change to a P-MPR based on the predicted MPE event takes effect. For example, the first time in the future may be indicated as a time at which a change to the P-MPR takes effect, or a time associated with the beginning of the predicted future MPE event such that the P-MPR takes effect at a time that precedes the first time in the future by a configured time offset (e.g., a time offset configured to allow any mitigating operation to be complete before the first future time). In some aspects, a confidence measure for a predicted future MPE event that was calculated when making the prediction may be associated with the indication of the predicted future MPE event, while in some aspects the indication of the predicted future MPE event is based on the calculated confidence measure being above a threshold confidence value as discussed above.

In some aspects, the indication of the predicted future MPE event may be received in a report that indicates multiple MPE events (e.g., one or more predicted future MPE events and/or measured MPE events). In some aspects enabling reporting for multiple component carriers and/or beams, the report identifies one or more of a particular component carrier or a particular beam for each of the multiple MPE events. The indication of the predicted future MPE event, in some aspects, may indicate one or more of a plurality of component carriers (e.g., associate with CA) or one or more of a plurality of beams (e.g., beams associated with a same TRP and/or beam group) for which the future MPE event is predicted to occur. The plurality of component carriers and/or the plurality of beams, in some aspects, may be indicated based on a group to which the plurality of component carriers or the plurality of beams belongs.

The indication of the predicted future MPE event, in some aspects, may indicate at least one of a predicted power headroom or an UL RSRP at a predicted time of the future MPE event based on at least one of a path loss prediction or the predicted future MPE event. The indication of the predicted future MPE event, in some aspects, may indicate one or more of a recommended beam (e.g., based on a beam sweeping operation initiated by the request at 1008), a recommended MCS, or a recommended number of MIMO layers for the UL transmission. For example, referring to FIG. 6, the base station 602 may receive, and the UE 604 may transmit, the MPE event indication 618.

In some aspects, the base station may receive an additional indication of a measured MPE event. The additional indication of the measured MPE event, in some aspects, may indicate that the measured MPE event is a measured MPE event as opposed to a predicted future MPE event, e.g., by including a future timestamp value of ‘0’ or other value that is used to identify a current measured MPE event. For example, referring to FIG. 6, the base station 602 may receive, and the UE 604 may transmit, the MPE event indication 618 that includes an additional indication of a measured MPE event.

The base station, in some aspects, may receive a prediction-realization indication indicating whether the predicted future MPE event is detected. The prediction-realization indication, in some aspects, may indicate that the predicted future MPE event has become a measured MPR event. The prediction-realization indication may indicate for the base station to implement a recommended adjustment and/or update to a configuration of the communication between the UE and the network node. Alternatively, if the prediction-realization indication indicates that the predicted future MPE event has not become a measured MPE event, the prediction-realization indication may indicate for the base station to not implement the recommended adjustment and/or update to a configuration of the communication between the wireless device and the base station. For example, if a human body part fails to enter into the exposure zone as predicted the predicted future MPE event may be indicated to not be realized and may further indicate for the recommended adjustment and/or update to a configuration of the communication between the wireless device and the base station to not be implemented (e.g. to be ignored). For example, referring to FIG. 6, the base station 602 may receive, and UE 604 may transmit, predicted MPE event realization indication 622 indicating that the predicted future MPE event has (or has not) become a measured MPR event.

Assuming that the prediction-realization indication indicates that the predicted future MPE event has become a measured MPR event, the base station may at 1016, adjust at least one characteristic of a communication with the wireless device based on the indication of the predicted future MPE event. For example, 1016 may be performed by CU processor 1312, DU processor 1332, RU processor 1342, network processor 1312, and/or future MPE event mitigation component 199 of FIG. 13. In some aspects, the at least one characteristic of the communication may be adjusted based on a timeline that starts from the transmission of the indication of the predicted future MPE event, or a reception of an acknowledgment of the indication. The timeline, in some aspects, may have a length based on at least one of a timing indicated for the predicted future MPE event or a time threshold (e.g., an amount of time before an indicated future time associated with the predicted future MPE event). For example, referring to FIG. 6, the UE 604 and the base station 602 may adjust, at 624, at least one characteristic of a communication between the UE 604 and the base station 602 based on the indication of the predicted future MPE event included in MPE event indication 618.

Finally, at 1018, the base station may communicate with the network node using the at least one characteristic adjusted at 1016 based on the indication of the predicted future MPE event. For example, 1018 may be performed by CU processor 1312, DU processor 1332, RU processor 1342, network processor 1312, transceiver(s) 1346, antennas 1380, and/or future MPE event mitigation component 199 of FIG. 13. The communication at 1018, in some aspects, may be based on one or more of an adjusted beam, MCS, or number of MIMO layers for a UL transmission associated with the predicted future MPE event. For example, referring to FIG. 6, the UE 604 and the base station 602 may engage in communication 628 based on the at least one characteristic adjusted at 624.

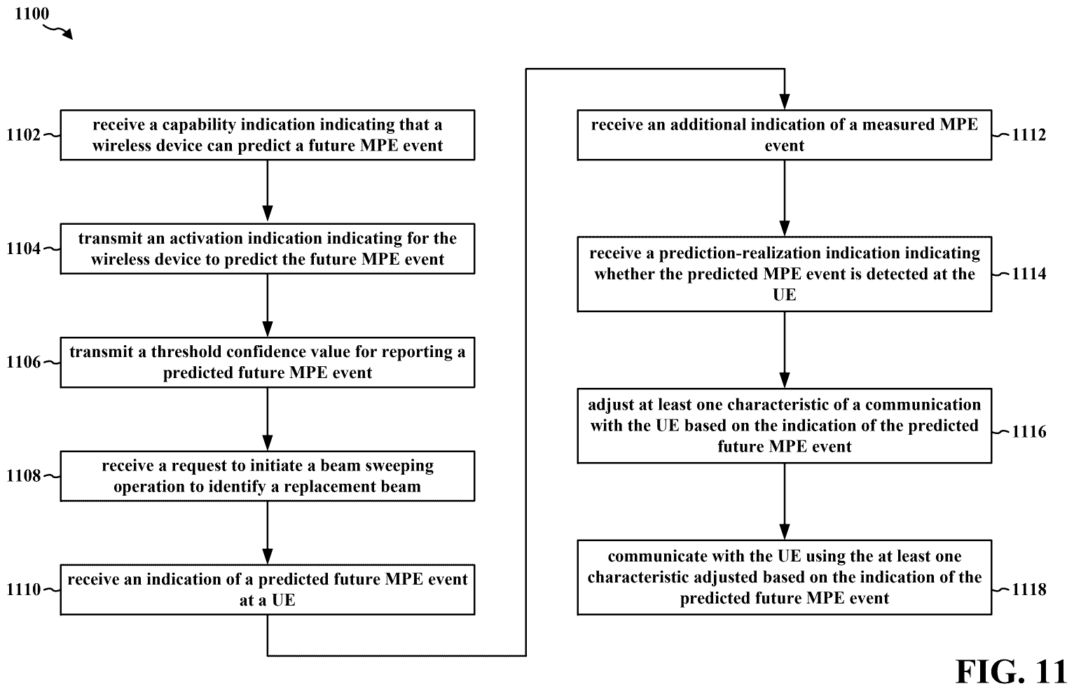

FIG. 11 is a flowchart 1100 of a method of wireless communication. The method may be performed by a network node such as a base station (e.g., the base station 102 402, 602; the network entity 1302). At 1102, the base station may receive a capability indication, associated with a wireless device (e.g., a UE) indicating that the wireless device can predict a future MPE event. For example, 1102 may be performed by CU processor 1312, DU processor 1332, RU processor 1342, network processor 1312, transceiver(s) 1346, antennas 1380, and/or future MPE event mitigation component 199 of FIG. 13. The capability indication, in some aspects, may be transmitted by the wireless device and may be included in an initial access process or may be transmitted via RRC signaling. In some aspects, the capability indication indicates a maximum number of beams for which future MPE events can be predicted by the wireless device. For example, referring to FIG. 6, the base station 602 may receive, and the UE 604 may transmit, future MPE event reporting capability indication 606 indicating the capacity to predict future MPE events and, in some aspects, an indication of a maximum number of beams for which future MPE events may be predicted.

At 1104, the base station may transmit an activation indication indicating for the wireless device to predict one or more future MPE events. The activation indication, in some aspects, may be transmitted based on the capability indication received at 1102. For example, 1104 may be performed by CU processor 1312, DU processor 1332, RU processor 1342, network processor 1312, transceiver(s) 1346, antennas 1380, and/or future MPE event mitigation component 199 of FIG. 13. The activation indication, in some aspects, may also include configuration information regarding a maximum number of beams for which to predict future MPE events and configuration information for reporting predicted future MPE events. In some aspects, the activation indication may be transmitted via RRC signaling. For example, referring to FIG. 6, the base station 602 may transmit, and UE 604 may receive, activation and/or configuration 608 indicating for the UE 604 to enable future MPE event prediction and, in some aspects, to configure the prediction at, and/or the reporting from, the UE 604.

At 1106, the base station may transmit a threshold confidence value for reporting a predicted future MPE event. For example, 1106 may be performed by CU processor 1312, DU processor 1332, RU processor 1342, network processor 1312, transceiver(s) 1346, antennas 1380, and/or future MPE event mitigation component 199 of FIG. 13. The threshold confidence value may be used by the wireless device to determine whether to send an indication (or report) for a predicted future MPE event, where the indication of the predicted future MPE event is transmitted by the UE and received by the base station when the confidence measure is above a threshold confidence value. For example, referring to FIG. 6, the base station 602 may transmit, and UE 604 may receive, activation and/or configuration 608 indicating for the UE 604 to enable future MPE event prediction, where the activation and/or configuration 608 includes a threshold confidence value for reporting a predicted future MPE event.

In some aspects, the UE may be responsible, in some aspects, for monitoring Tx power and a proximity of a human (or a body part of a human) to enforce the MPE limits (e.g., an MPE threshold). The UE may enforce the MPE limits in conjunction with the network node by reporting MPE events associated with scheduled UL transmissions and/or UL resource grants for the network node to reconfigure the scheduled UL transmissions or UL resource grants to comply with the MPE limits. In order to facilitate the MPE limit enforcement, at 1108, the base station may receive, at 1108, a request to initiate a beam sweeping operation to identify a replacement beam (e.g., an alternative beam). For example, 1108 may be performed by CU processor 1312, DU processor 1332, RU processor 1342, network processor 1312, transceiver(s) 1346, antennas 1380, and/or future MPE event mitigation component 199 of FIG. 13. The request may be received at 1108, in some aspects, in order to allow the wireless device to determine an alternative to a currently used beam to include in a report or indication of the predicted future MPE event. For example, referring to FIG. 6, the base station 602 may receive, and UE 604 may transmit, the beam sweeping initiation request 614. As discussed above, a beam sweeping operation 616 may then be performed to allow the UE 604 to identify one or more candidate alternative or replacement beams for the currently used beam.

At 1110, the base station may receive an indication of a predicted future MPE event. For example, 1110 may be performed by CU processor 1312, DU processor 1332, RU processor 1342, network processor 1312, transceiver(s) 1346, antennas 1380, and/or future MPE event mitigation component 199 of FIG. 13. The indication of the predicted future MPE event, in some aspects, includes a future timestamp associated with the predicted future MPE event. The future timestamp, in some aspects, may indicate a time at which a change to a P-MPR based on the predicted MPE event takes effect. For example, the first time in the future may be indicated as a time at which a change to the P-MPR takes effect, or a time associated with the beginning of the predicted future MPE event such that the P-MPR takes effect at a time that precedes the first time in the future by a configured time offset (e.g., a time offset configured to allow any mitigating operation to be complete before the first future time). In some aspects, a confidence measure for a predicted future MPE event that was calculated when making the prediction may be associated with the indication of the predicted future MPE event, while in some aspects the indication of the predicted future MPE event is based on the calculated confidence measure being above a threshold confidence value as discussed above.

In some aspects, the indication of the predicted future MPE event may be received in a report that indicates multiple MPE events (e.g., one or more predicted future MPE events and/or measured MPE events). In some aspects enabling reporting for multiple component carriers and/or beams, the report identifies one or more of a particular component carrier or a particular beam for each of the multiple MPE events. The indication of the predicted future MPE event, in some aspects, may indicate one or more of a plurality of component carriers (e.g., associate with CA) or one or more of a plurality of beams (e.g., beams associated with a same TRP and/or beam group) for which the future MPE event is predicted to occur. The plurality of component carriers and/or the plurality of beams, in some aspects, may be indicated based on a group to which the plurality of component carriers or the plurality of beams belongs.

The indication of the predicted future MPE event, in some aspects, may indicate at least one of a predicted power headroom or an UL RSRP at a predicted time of the future MPE event based on at least one of a path loss prediction or the predicted future MPE event. The indication of the predicted future MPE event, in some aspects, may indicate one or more of a recommended beam (e.g., based on a beam sweeping operation initiated by the request at 1108), a recommended MCS, or a recommended number of MIMO layers for the UL transmission. For example, referring to FIG. 6, the base station 602 may receive, and the UE 604 may transmit, the MPE event indication 618.

In some aspects, the base station may receive, at 1112, an additional indication of a measured MPE event. For example, 1112 may be performed by CU processor 1312, DU processor 1332, RU processor 1342, network processor 1312, transceiver(s) 1346, antennas 1380, and/or future MPE event mitigation component 199 of FIG. 13. The additional indication of the measured MPE event, in some aspects, may indicate that the measured MPE event is a measured MPE event as opposed to a predicted future MPE event, e.g., by including a future timestamp value of ‘0’ or other value that is used to identify a current measured MPE event. For example, referring to FIG. 6, the base station 602 may receive, and the UE 604 may transmit, the MPE event indication 618 that includes an additional indication of a measured MPE event.

The base station, in some aspects, may receive, at 1114, a prediction-realization indication indicating whether the predicted future MPE event is detected. For example, 1114 may be performed by CU processor 1312, DU processor 1332, RU processor 1342, network processor 1312, transceiver(s) 1346, antennas 1380, and/or future MPE event mitigation component 199 of FIG. 13. The prediction-realization indication, in some aspects, may indicate that the predicted future MPE event has become a measured MPR event. The prediction-realization indication may indicate for the base station to implement a recommended adjustment and/or update to a configuration of the communication between the UE and the network node.

Alternatively, if the prediction-realization indication indicates that the predicted future MPE event has not become a measured MPE event, the prediction-realization indication may indicate for the base station to not implement the recommended adjustment and/or update to a configuration of the communication between the wireless device and the base station. For example, if a human body part fails to enter into the exposure zone as predicted the predicted future MPE event may be indicated to not be realized and may further indicate for the recommended adjustment and/or update to a configuration of the communication between the wireless device and the base station to not be implemented (e.g. to be ignored). For example, referring to FIG. 6, the base station 602 may receive, and UE 604 may transmit, predicted MPE event realization indication 622 indicating that the predicted future MPE event has (or has not) become a measured MPR event.

Assuming that the prediction-realization indication indicates that the predicted future MPE event has become a measured MPR event, the base station may at 1116, adjust at least one characteristic of a communication with the wireless device based on the indication of the predicted future MPE event. For example, 1116 may be performed by CU processor 1312, DU processor 1332, RU processor 1342, network processor 1312, and/or future MPE event mitigation component 199 of FIG. 13. In some aspects, the at least one characteristic of the communication may be adjusted based on a timeline that starts from the transmission of the indication of the predicted future MPE event, or a reception of an acknowledgment of the indication. The timeline, in some aspects, may have a length based on at least one of a timing indicated for the predicted future MPE event or a time threshold (e.g., an amount of time before an indicated future time associated with the predicted future MPE event). In some aspects, adjusting the at least one characteristic of the communication with the wireless device at 1116 may include at least one of adjusting a number of resources allocated for an UL communication, a spatial filter (e.g., a beam) associated with the UL communication, or a power associated with an UL communication from the UE at a time associated with the predicted future MPE event. Adjusting the at least one characteristic of the communication with the wireless device at 1116, in some aspects, may include at least one of adjusting the beam based on a recommended beam, adjusting the MCS based on a recommended MCS, or adjusting the number of UL layers based on a recommended number of UL layers. For example, referring to FIG. 6, the UE 604 and the base station 602 may adjust, at 624, at least one characteristic of a communication between the UE 604 and the base station 602 based on the indication of the predicted future MPE event included in MPE event indication 618.

Finally, at 1118, the base station may communicate with the network node using the at least one characteristic adjusted at 1116 based on the indication of the predicted future MPE event. For example, 1118 may be performed by CU processor 1312, DU processor 1332, RU processor 1342, network processor 1312, transceiver(s) 1346, antennas 1380, and/or future MPE event mitigation component 199 of FIG. 13. The communication at 1118, in some aspects, may be based on one or more of an adjusted beam, MCS, or number of MIMO layers for a UL transmission associated with the predicted future MPE event. For example, referring to FIG. 6, the UE 604 and the base station 602 may engage in communication 628 based on the at least one characteristic adjusted at 624.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see 350 of FIG. 3) and include the additional modules of the apparatus 1204.

As discussed supra, the future MPE event prediction and reporting component 198 is configured to communicate with a network device. The future MPE event prediction and reporting component 198 may further be configured predict a future MPE event at the wireless device and to transmit, for the network device, an indication of the predicted future MPE event. The future MPE event prediction and reporting component 198, in some aspects, may further be configured to perform any aspect discussed in connection with the call flow diagram or the flow diagrams illustrated in FIGS. 6, 8, and 9. The future MPE event prediction and reporting component 198 may be within the cellular baseband processor 1224, the application processor 1206, or both the cellular baseband processor 1224 and the application processor 1206. The future MPE event prediction and reporting component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for communicating with a network device; means for transmitting a capability indication indicating that the wireless device can predict a future MPE event; means for receiving an activation indication indicating for the wireless device to predict the future MPE event; means for predicting a future MPE event at the wireless device; means for calculating a confidence measure associated with the predicted MPE event; transmitting, to the network device, an indication of the predicted future MPE event; means for transmitting a request to initiate a beam sweeping operation to identify a replacement beam; means for transmitting an additional indication of a measured MPE event; means for measuring characteristics of the communication based on the timestamp associated with the predicted MPE event; means for transmitting a prediction-realization indication indicating whether the predicted MPE event is detected based on the measured characteristics; means for adjusting at least one characteristic of a communication with the network device based on the indication of the predicted future MPE event; means for communicating with the network device using the at least one characteristic adjusted based on the indication of the predicted future MPE event; or means for monitoring the environment of the wireless device.

The means may be the future MPE event prediction and reporting component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the future MPE event mitigation component 199 is configured to receive an indication of a predicted future MPE event at a UE. The future MPE event mitigation component 199 may further be configured to adjust at least one characteristic of a communication with the UE based on the indication of the predicted future MPE event and to communicate with the UE using the at least one characteristic adjusted based on the indication of the predicted future MPE event. The future MPE event mitigation component 199, in some aspects, may further be configured to perform any aspect discussed in connection with the call flow diagram or the flow diagrams illustrated in FIGS. 6, 10, and 11. The future MPE event mitigation component 199 may be within one or more processors of one or more of the CU 1310, DU 1330, and the RU 1340. The future MPE event mitigation component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 includes means for a capability indication indicating that the UE can predict a future MPE event; means for transmitting an activation indication indicating for the UE to predict the future MPE event; means for transmitting a threshold confidence value for reporting a predicted future MPE event; means for receiving a request to initiate a beam sweeping operation to identify a replacement beam; means for receiving an indication of a predicted future MPE event at a UE; means for receiving an additional indication of a measured MPE event; means for receiving a prediction-realization indication indicating whether the predicted MPE event is detected at the UE; means for adjusting at least one characteristic of a communication with the UE based on the indication of the predicted future MPE event; and means for communicating with the UE using the at least one characteristic adjusted based on the indication of the predicted future MPE event. The means may be the future MPE event mitigation component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

As discussed above, a UE, in some aspects, may be configured to report a change in P-MPR in a power headroom report (PHR). An event triggered report in a PHR MAC-CE may be transmitted, in some aspects, when the P-MPR is larger than a first threshold and/or the change in the P-MPR is larger than a second threshold. In some aspects, A P-MPR field, in some aspects, may be indicated in a MAC-CE, e.g., in a P-MPR field of the MAC-CE. Currently, P-MPR associated with an MPE event may be reported for detected and/or measured MPE events based on current conditions. Aspects of the present disclosure provide a method and apparatus for predicting future MPE events and reporting the predicted future MPE events to enable improved MPE event mitigation (e.g., more efficient and/or preemptive mitigation) that is less disruptive to communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including communicating with a network device; predicting a future MPE event at the wireless device; and transmitting, to the network device, an indication of the predicted future MPE event.

Aspect 2 is the method of aspect 1, further including adjusting at least one characteristic of a communication with the network device based on the indication of the predicted future MPE event and communicating with the network device using the at least one characteristic adjusted based on the indication of the predicted future MPE event.

Aspect 3 is the method of any of aspects 1 and 2, where the at least one characteristic of the communication is adjusted based on a timeline that starts from the transmission of the indication of the predicted future MPE event, or a reception of an acknowledgment of the indication, the timeline having a length based on at least one of a timing indicated for the predicted future MPE event or a time threshold.

Aspect 4 is the method of any of aspects 1 to 3, where the indication of the predicted future MPE event includes a future timestamp associated with the predicted future MPE event, where the future timestamp indicates a time at which a change to a P-MPR based on the predicted future MPE event takes effect.

Aspect 5 is the method of aspect 4, further including transmitting an additional indication of a measured MPE event, where the additional indication indicates that the measured MPE event is a measured MPE event.

Aspect 6 is the method of any of aspects 4 and 5, further including measuring characteristics of the communication based on the timestamp associated with the predicted future MPE event and transmitting a prediction-realization indication indicating whether the predicted future MPE event is detected based on the measured characteristics.

Aspect 7 is the method of any of aspects 1 to 6, where the predicted future MPE event is transmitted in a report that indicates multiple MPE events, the report identifying one or more of a particular component carrier or a particular beam for each of the multiple MPE events.

Aspect 8 is the method of any of aspects 1 to 7, where the indication of the predicted future MPE event indicates one or more of a plurality of component carriers or one or more of a plurality of beams for which the predicted future MPE event is predicted to occur.

Aspect 9 is the method of aspect 8, where the plurality of component carriers or the plurality of beams is indicated based on a group to which the plurality of component carriers or the plurality of beams belongs.

Aspect 10 is the method of any of aspects 1 to 9, where, based on at least one of a path loss prediction or the predicted future MPE event, the indication indicates at least one of a predicted power headroom or an UL RSRP at a predicted time of the predicted future MPE event.

Aspect 11 is the method of any of aspects 1 to 10, where the indication of the predicted future MPE event indicates one or more of a recommended beam, a recommended MCS, or a recommended number of UL layers.

Aspect 12 is the method of any of aspects 1 to 11, further including transmitting a request to initiate a beam sweeping operation to identify a replacement beam, where the indication of the predicted future MPE event comprises a recommended beam that is different from a currently-used beam, wherein the recommended beam is based on the beam sweeping operation initiated based on the request.

Aspect 13 is the method of any of aspects 1 to 12, further including transmitting a capability indication indicating that the wireless device can predict a predicted future MPE event and receiving an activation indication indicating for the wireless device to predict the predicted future MPE event.

Aspect 14 is the method of aspect 13, where the capability indication indicates a maximum number of beams for which predicted future MPE events can be predicted by the wireless device.

Aspect 15 is the method of any of aspects 1 to 14, where predicting the predicted future MPE event includes calculating a confidence measure associated with the predicted future MPE event, where the indication of the predicted future MPE event is transmitted based on the confidence measure being above a threshold confidence value.

Aspect 16 is a method of wireless communication at a network node, including receiving an indication of a predicted future MPE event at a UE; adjusting at least one characteristic of a communication with the UE based on the indication of the predicted future MPE event; and communicating with the UE using the at least one characteristic adjusted based on the indication of the predicted future MPE event.

Aspect 17 is the method of aspect 16, where the indication of the predicted future MPE event includes a future timestamp associated with the predicted future MPE event, where the future timestamp indicates a time at which a change to a P-MPR based on the predicted future MPE event takes effect.

Aspect 18 is the method of aspect 17, further including receiving an additional indication of a measured MPE event, where the additional indication indicates that the measured MPE event is a measured MPE event.

Aspect 19 is the method of any of aspects 16 to 18, further including receiving a prediction-realization indication indicating whether the predicted future MPE event is detected at the UE.

Aspect 20 is the method of any of aspects 16 to 19, where the indication of the predicted future MPE event is received in a report that indicates multiple MPE events, the report identifying one or more of a particular component carrier or a particular beam for each of the multiple MPE events.

Aspect 21 is the method of any of aspects 16 to 20, where the indication of the predicted future MPE event indicates one or more of a plurality of component carriers or one or more of a plurality of beams for which the predicted future MPE event is predicted to occur.

Aspect 22 is the method of any of aspects 16 to 21, where, based on at least one of a path loss prediction or the predicted future MPE event, the indication indicates at least one of a predicted power headroom or an UL reference signal received power at a predicted time of the predicted future MPE event, and where adjusting the at least one characteristic of the communication with the UE includes at least one of adjusting a number of resources allocated for an UL communication or a power associated with an UL communication from the UE at a time associated with the predicted future MPE event.

Aspect 23 is the method of any of aspects 16 to 22, where the indication of the predicted future MPE event indicates one or more of a recommended beam, a recommended MCS, or a recommended number of UL layers, and where adjusting the at least one characteristic of the communication with the UE includes one or more of adjusting the beam based on the recommended beam, adjusting the MCS based on the recommended MCS, or adjusting the number of UL layers based on the recommended number of UL layers.

Aspect 24 is the method of any of aspects 16 to 23, further including receiving a request to initiate a beam sweeping operation to identify a replacement beam, where the indication of the predicted future MPE event includes a recommended beam based on the beam sweeping operation initiated based on the request that is different from a currently-used beam.

Aspect 25 is the method of any of aspects 16 to 24, further including receiving a capability indication indicating that the UE can predict a future MPE event and transmitting an activation indication indicating for the UE to predict the future MPE event.

Aspect 26 is the method of aspect 25, where the capability indication indicates a maximum number of beams for which future MPE events can be predicted by the wireless device.

Aspect 27 is the method of any of aspects 16 to 26, the predicted future MPE event is associated with a confidence measure for the prediction, the method further including transmitting a threshold confidence value for reporting a predicted future MPE event, where the indication of the predicted future MPE event is received based on the confidence measure being above a threshold confidence value.

Aspect 28 is an apparatus for wireless communication at a device including a memory and at least one processor coupled to the memory and, based at least in part on information stored in the memory, the at least one processor is configured to implement any of aspects 1 to 27.

Aspect 29 is the method of aspect 28, further including a transceiver or an antenna coupled to the at least one processor.

Aspect 30 is an apparatus for wireless communication at a device including means for implementing any of aspects 1 to 27.

Aspect 31 is a computer-readable medium (e.g., a non-transitory computer-readable medium) storing computer executable code, where the code when executed by a processor causes the processor to implement any of aspects 1 to 27.

What is claimed is:

1. An apparatus for wireless communication at a wireless device, comprising:
a memory; and
at least one processor coupled to the memory and, based at least in part on information stored in the memory, the at least one processor is configured to:
communicate with a network device;
predict a future maximum permissible exposure (MPE) event at the wireless device; and
transmitting, for the network device, an indication of the predicted future MPE event.

2. The apparatus of claim 1, the at least one processor further configured to:
adjust at least one characteristic of a communication with the network device based on the indication of the predicted future MPE event; and
communicate with the network device using the at least one characteristic adjusted based on the indication of the predicted future MPE event.

3. The apparatus of claim 2, wherein the at least one processor is configured to adjust the at least one characteristic of the communication based on a timeline that starts from transmitting the indication of the predicted future MPE event, or a reception of an acknowledgment of the indication, the timeline having a length based on at least one of a timing indicated for the predicted future MPE event or a time threshold.

4. The apparatus of claim 1, wherein the indication of the predicted future MPE event comprises a future timestamp associated with the predicted future MPE event, wherein the future timestamp indicates a time at which a change to a power management maximum power reduction (P-MPR) based on the predicted future MPE event takes effect.

5. The apparatus of claim 4, the at least one processor further configured to:
transmit an additional indication of a measured MPE event, wherein the additional indication indicates that the measured MPE event is a measured MPE event.

6. The apparatus of claim 4, the at least one processor further configured to:
measure characteristics of the communication based on the future timestamp associated with the predicted future MPE event; and
transmit a prediction-realization indication indicating whether the predicted future MPE event is detected based on the measured characteristics.

7. The apparatus of claim 1, wherein the indication of the predicted future MPE event is transmitted in a report that indicates multiple MPE events, the report identifying one or more of a particular component carrier or a particular beam for each of the multiple MPE events.

8. The apparatus of claim 1, wherein the indication of the predicted future MPE event indicates one or more of a plurality of component carriers or one or more of a plurality of beams for which the predicted future MPE event is predicted to occur.

9. The apparatus of claim 8, wherein the plurality of component carriers or the plurality of beams is indicated based on a group to which the plurality of component carriers or the plurality of beams belongs.

10. The apparatus of claim 1, wherein, based on at least one of a path loss prediction or the predicted future MPE event, the indication indicates at least one of a predicted power headroom or an uplink (UL) reference signal received power (RSRP) at a predicted time of the predicted future MPE event.

11. The apparatus of claim 1, wherein the indication of the predicted future MPE event indicates one or more of a recommended beam, a recommended modulation and coding scheme (MCS), or a recommended number of uplink (UL) layers.

12. The apparatus of claim 1, the at least one processor further configured to:
transmit a request to initiate a beam sweeping operation to identify a replacement beam, wherein the indication of the predicted future MPE event comprises a recommended beam that is different from a currently-used beam, wherein the recommended beam is based on the beam sweeping operation initiated based on the request.

13. The apparatus of claim 1, the at least one processor further configured to:
transmit a capability indication indicating that the wireless device can predict a future MPE event; and
receive an activation indication indicating for the wireless device to predict the future MPE event.

14. The apparatus of claim 13, wherein the capability indication indicates a maximum number of beams for which future MPE events can be predicted by the wireless device.

15. The apparatus of claim 1, wherein the at least one processor configured to predict the predicted future MPE event is further configured to calculate a confidence measure associated with the predicted future MPE event, wherein the indication of the predicted future MPE event is transmitted based on the confidence measure being above a threshold confidence value.

16. An apparatus for wireless communication at a network node, comprising:
a memory; and
at least one processor coupled to the memory and, based at least in part on information stored in the memory, the at least one processor is configured to:
receive an indication of a predicted future maximum permissible exposure (MPE) event at a user equipment (UE);
adjust at least one characteristic of a communication with the UE based on the indication of the predicted future MPE event; and
communicate with the UE using the at least one characteristic adjusted based on the indication of the predicted future MPE event.

17. The apparatus of claim 16, wherein the indication of the predicted future MPE event comprises a future timestamp associated with the predicted future MPE event, wherein the future timestamp indicates a time at which a change to a power management maximum power reduction (P-MPR) based on the predicted future MPE event takes effect.

18. The apparatus of claim 17, the at least one processor further configured to:
receive an additional indication of a measured MPE event, wherein the additional indication indicates that the measured MPE event is a measured MPE event.

19. The apparatus of claim 16, the at least one processor further configured to:
receive a prediction-realization indication indicating whether the predicted future MPE event is detected at the UE.

20. The apparatus of claim 16, wherein the indication of the predicted future MPE event is received in a report that indicates multiple MPE events, the report identifying one or more of a particular component carrier or a particular beam for each of the multiple MPE events.

21. The apparatus of claim 16, wherein the indication of the predicted future MPE event indicates one or more of a plurality of component carriers or one or more of a plurality of beams for which the predicted future MPE event is predicted to occur.

22. The apparatus of claim 16,
wherein, based on at least one of a path loss prediction or the predicted future MPE event, the indication indicates at least one of a predicted power headroom or an uplink (UL) reference signal received power at a predicted time of the predicted future MPE event, and
wherein the at least one processor is configured to adjust the at least one characteristic of the communication with the UE by at least one of adjusting a number of resources allocated for an UL communication, a spatial filter associated with the UL communication, or a power associated with an UL communication from the UE at a time associated with the predicted future MPE event.

23. The apparatus of claim 16,
wherein the indication of the predicted future MPE event indicates one or more of a recommended beam, a recommended modulation and coding scheme (MCS), or a recommended number of uplink (UL) layers, and
wherein the at least one processor is configured to adjust the at least one characteristic of the communication with the UE by one or more of adjusting a beam based on the recommended beam, adjusting an MCS based on the recommended MCS, or adjusting a number of UL layers based on the recommended number of UL layers.

24. The apparatus of claim 16, the at least one processor further configured to:
receive a request to initiate a beam sweeping operation to identify a replacement beam, wherein the indication of the predicted future MPE event comprises a recommended beam that is different from a currently-used beam, wherein the recommended beam is based on the beam sweeping operation initiated based on the request.

25. The apparatus of claim 16, the at least one processor further configured to:
receive a capability indication indicating that the UE can predict a future MPE event; and
transmit an activation indication indicating for the UE to predict the future MPE event.

26. The apparatus of claim 25 wherein the capability indication indicates a maximum number of beams for which future MPE events can be predicted by the UE.

27. The apparatus of claim 16, wherein the predicted future MPE event is associated with a confidence measure for the predicted future MPE event, the at least one processor further configured to:
transmit a threshold confidence value for reporting a predicted future MPE event, wherein the indication of the predicted future MPE event is received based on the confidence measure being above the threshold confidence value.

28. A method of wireless communication at a wireless device, the method comprising:
communicating with a network device;
predicting a future maximum permissible exposure (MPE) event at the wireless device; and
transmitting, for the network device, an indication of the predicted future MPE event.

29. The method of claim 28, further comprising:
adjusting at least one characteristic of a communication with the network device based on the indication of the predicted future MPE event; and
communicating with the network device using the at least one characteristic adjusted based on the indication of the predicted future MPE event.

30. A method of wireless communication at a network node, the method comprising:
receiving an indication of a predicted future maximum permissible exposure (MPE) event at a user equipment (UE);
adjusting at least one characteristic of a communication with the UE based on the indication of the predicted future MPE event; and
communicating with the UE using the at least one characteristic adjusted based on the indication of the predicted future MPE event.
